(19) United States
(12) Patent Application Publication
(10) Pub. No.: US 2022/0222668 A1
(43) Pub. Date: Jul. 14, 2022

(54) SYSTEM FOR VERIFICATION AND MANAGEMENT FOR DIGITALLY PAIRED COLLECTABLES AND MEMORABILIA

(71) Applicant: Scientia Potentia Est., LLC, Charleston, SC (US)

(72) Inventors: Jeremy Blackburn, Charleston, SC (US); Justin Southward, Fort Meyers, FL (US); W. Kurt Taylor, N. Charleston, SC (US); Karl David, Charleston, SC (US); Austi Critchfield, Clearwater, FL (US); Michael Lu, N. Charleston, SC (US); Tim McVicker, Charleston, SC (US)

(73) Assignee: Scientia Potentia Est., LLC, Charleston, SC (US)

(21) Appl. No.: 17/531,598

(22) Filed: Nov. 19, 2021

Related U.S. Application Data
(63) Continuation-in-part of application No. 17/344,043, filed on Jun. 10, 2021.
Application No. 17/344,043 is a continuation-in-part of application No. 17/230,911, filed on Apr. 14, 2021, now Pat. No. 11,288,761.
Application No. 17/230,911 is a continuation-in-part of application No. 17/176,056, filed on Feb. 15, 2021, now Pat. No. 11,288,308.
Application No. 17/176,056 is a continuation-in-part of application No. 17/128,084, filed on Dec. 19, 2020.
Application No. 17/128,084 is a continuation-in-part of application No. 16/997,840, filed on Aug. 19, 2020.
Application No. 16/997,840 is a continuation-in-part of application No. 16/994,585, filed on Aug. 15, 2020, now Pat. No. 11,232,652.
Application No. 16/994,585 is a continuation-in-part of application No. 16/991,916, filed on Aug. 12, 2020, now Pat. No. 11,216,823.
Application No. 16/991,916 is a continuation-in-part of application No. 16/876,080, filed on May 17, 2020.
Application No. 16/876,080 is a continuation-in-part of application No. 16/810,782, filed on Mar. 5, 2020, now Pat. No. 11,216,781.
Application No. 16/810,782 is a continuation-in-part of application No. 16/510,642, filed on Jul. 12, 2019, now Pat. No. 11,216,772.
Application No. 16/510,642 is a continuation-in-part of application No. 16/510,634, filed on Jul. 12, 2019, now Pat. No. 10,713,737.
Application No. 16/510,642 is a continuation-in-part of application No. 16/452,076, filed on Jun. 25, 2019, now abandoned.
Application No. 16/510,634 is a continuation-in-part of application No. 16/452,076, filed on Jun. 25, 2019, now abandoned.

(51) Int. Cl. G06Q 20/40; G06Q 20/20; G06F 16/245

(52) U.S. Cl. CPC G06Q 20/4014; G06F 16/245; G06Q 20/208; G06Q 20/4015

(57) ABSTRACT

This system if directed to verifiably pairing an asset with a digital representation and can include a computer system disposed at a use location and in communication with a persistent storage and a set of non-transitory computer readable instructions included in the computer system adapted for: creating an asset record, creating a significance record, associating the significant record with the virtual representation, storing the asset record and the associated significance record on the persistence storage, creating a transaction record representing a transfer of the asset from a first entity to a second entity wherein the transaction record includes a transaction verification, transmitting a payment request according the transaction verification to a second entity account representing payment for the asset from the second entity to the first entity, and, storing the asset record and the associated significance record of provenance of the item and owner identification on the persistence storage.

### RELATED APPLICATIONS

This application is a continuation in part of U.S. application Ser. No. 17/344,043 filed Jun. 10, 2021 which in turn is a continuation in part of U.S. application Ser. No. 17/230,911 filed Apr. 14, 2021 which in turn is a continuation in part of U.S. application Ser. No. 17/176,056 filed Feb. 15, 2021 which in turn is a continuation in part of U.S. application No. 17/128,084 filed Dec. 19, 2020 which in turn is a continuation in part of U.S. application Ser. No. 16/997,840 filed Aug. 19, 2020, which is a continuation in part of U.S. application Ser. No. 16/994,585 filed Aug. 15, 2020 which in turn is a continuation in part of U.S. patent application Ser. No. 16/991,916 filed on Aug. 12, 2020 which in turn is a continuation in part of U.S. patent application Ser. No. 16/876,080 filed May 17, 2020 which in turn is a continuation in part of U.S. patent application Ser. No. 16/810,782 filed on Mar. 5, 2020 which in turn is a continuation in part of U.S. patent application Ser. No. 16/510,634 filed on July 12, 2019 (now U..S. Pat. No. 10,713,737 issued Jul. 14, 2020) and U.S. patent application Ser. No. 16/510,642 filed on Jul. 12, 2019, which are all incorporated by reference. patent application Ser. Nos. 16/510,542 and 16/510,634 are both continuations of U.S. patent application Ser. No. 16/452,076 filed Jun. 25, 2019, which all are incorporated by reference.

### BACKGROUND

### 1) Field of The System

A system for pairing physical articles such as collectibles and memorabilia and virtual representation to verify a link between as asset with its virtual representation to create a undichotomized pair that can be used for authentication, verification, anti-counterfeit, appraisals, auditing, recording and the like of the status, activity, and transactions associated with the article including, such items and physical articles, including collectibles, memorabilia, photos, artwork and the like and non-fungible tokens including digital images and digital artwork.

### 2) Background.

There has been a significant market for certain physical articles that have been known as memorabilia, collectables, and other names. This market includes a wide variety of articles such as artwork, baseball cards, Legos®, sports uniforms and other clothing, jewelry, signatures, stamps, sculptures, wine, books, including graphic novels, and others. For example, it was reported that the original 1952 Topps Mickey Mantle sold for $5.2 million, a Babe Ruth uniform sold for over $5.6 million and two Jackie Robinson contracts were appraised and insured for $36 million. A Treskilling yellow stamp sold for $2.3 million with the fact that only one copy of the stamp being found contributing to its value. While these examples are at the top of valuations, the market for collectibles has been estimated to be $273 billion in 2020, with an annual market estimated somewhere between $20 and $40billion The collectibles market includes may articles that can be in the price range of these articles listed above to the more common ranges such as a signed Pete Rose baseball for $42.00, Andre Agassi signed tennis racket for $399.00 and signed Peyton Manning football for $699.99. An asset can include tangible and intangible items that an individual may possess and others may wish to possess. An buyer can be willing to exchange value to the owner of the object for the transfer of ownership or possession rights to the buyer. The object and related transaction currently relies upon trust between the parties. Without this trust will, the value can be reduced or eliminated. A system that relies upon trust, especially unverified trust, is not as desirable as one where reliance on trust is eliminated and replaced with verifiable truth. Such a system is needed to provide the parties to a transaction improved value for the asset and can reduce or eliminate the risk of fraud,

This market has also given rise to the problem of counterfeiting and authenticity. Common counterfeits are made and distributed for counterfeit artwork, sports memorabilia, autographs, wine, jewelry, and others. Once authentication company reported that in 2012 it analyzed approximately three hundred and fifty thousand autographs and discovered that autographs that were not authenticated were over fifty percent (50%). Media articles have reported that fraud is expected in somewhere between 50 to 80% of all memorabilia. Without improvements in the industry, this percentage of fraudulent activity is not expected to decrease, These levels of fraud affect consumers or originators of the memorabilia significantly by decreasing consumer confidence and lowering values due to concerns over authenticity.

Further, there were several specific autographs that were identified and commonly counterfeit such as Babe Ruth, Lou Gehrig, Mickey Mantle, Michael Jordan, and Muhammad Ali. To protect against counterfeits, consumers can have articles authenticated which can take time and money and in some cases is not practical. For examples, at trade shows, time and procedures of the trade show may not allow an article to be authenticated prior to a buyer purchasing the article. Further, the typical consumer generally does not have the skill or experience to easily detect a counterfeit. Counterfeits have resulted in substantial loss to the world economy, Organization for Economic Cooperation and Development and the EUIPO jointly published a 2019 report, “Illicit trade: trends in trade in counterfeit and pirated goods”, based on 2016 world seizure data of counterfeit and pirated goods that attempts to measure the scale of the problem. Based on their findings, the international trade in counterfeit and pirated products could have amounted to as much as $509 billion in 2016, estimated to be 3.3% of world trade—up from $461 billion in 2013, representing 2.5% of world trade.

One method of reducing the risk of counterfeit is for an article to have “paperwork” or a Certificate of Authenticity (COA) Unfortunately, there are counterfeit COA's and some unscrupulous makers will counterfeit the article and then provide the counterfeit article with a counterfeit COA. Further, the COA has become misunderstood and the mere fact that a seller provides a COA can mislead the buyer into believing that the article is authentic. Even were the CAO to be authentic, the COA should accompany every purchase of an article and include detailed information about the article. For example, a COA for artwork should Include detailed information such as artist name, title of the work, year of completion, dimensions, medium, edition number (if applicable), any special instructions and a sample or complete image of the artwork.

Having a system that reduces or eliminates the ability of the public to be deceived by counterfeits is a problem which deserves much attention.

One attempt to provide for improved authentication of collectibles is shown in U.S. Pat. Nos. 10,942,933 and 10,445,330 disclose a system and method of grading and authenticating collectibles utilizing digital imaging devices and processes to provide an objective, standardized, consistent high-resolution grading of collectible objects, such as but not limited to sport and non-sport trading cards. However, these attempts focus on the physical article (i.e., baseball card) and includes an analysis of characteristics of the baseball card that are universally examined in the grading process such as centering, corners, edges, and surface. For example, there are industry standards that determine the percentage of “off center” that an image can be to determine the potential for a counterfeit. However, this reference makes no mention of a digital twin.

U.S. Pat. No. 10,210,527 discloses an identity system that enables users and machines to identify, authenticate and interact with products and collectibles without relying on a third-party controlled authentication service that uses wireless tamperproof tags. The system uses an open registry database where a chain of ownership of the items is able to be stored. The open registry enables public access to the item identity and data combined with item registration anonymity.

Through appropriate digitization, an article such as a collectible can be converted into a digital representation such a digital the and stored on a database. In the current systems, especially with digital representations and COAs, there is a significant risk of scams, frauds, and irregularities with the articles. Further, a significant disadvantage with current digital systems is the potential for rehypothecation. Hypothecation means posting an asset as collateral for a debt so that in the event of a default, the asset can be seized (e.g., foreclosure or repossession) to satisfy the default at least partially on the debt. Rehypothecation is when the creditor uses the collateral from a first loan (e.g., original loan) and uses it as collateral for a second loan. Rehypothecation increases uncertainty and adds risk in that actual ownership, lien, or collateral can become uncertain. Digitization alone does not provide a solution as there is no ability to insure that the digital representation of the object or event. Further, mere digitization does not provide information such as data directed to when, where, who or what was or is associated with an object or event. Even certificates of authenticity have been shown to be susceptible to fraud.

There is also an issue with a chain of title or custody for articles such as collectibles. Current systems have a lack of accountability, verification and reliability of information related to the article and transactions. The inability to verify or authenticate articles and other factors can result in loss, mistakes, increased insurance claims, fraud, and increased insurance premiums. While there have been some attempts to add item information to a physical material, such as U.S. Pat. No. 8,321,302, these attempts have focused on tracking inventory levels and do not include verifiably pairing a physical material with a virtual representation that can be tracked throughout a process. Further, these prior attempts focus on a single location and do not consider the fact that the physical location of the article can be at separate locations. This disadvantage can be seen in U.S. Pat. No. 8,521,620 which specifically states that it a RFID tag is lost or damaged, the system allows a user to enter an item number or style and tags of similar items are displayed, a new tag is generated and associated with the item having the lost or damaged tag. Once the RFID tag is lost or damaged, the physical asset is no longer associated with the virtual representation. While this system specifically allows for the replacement of RFID tags on the same item, it lacks the ability to verifiably pair the new tag with the physical asset.

The disadvantages of current systems are caused in part due to the lack of pairing the physical asset with the virtual representation to determine that the article promised and delivered are a properly physically and digitally paired. Attempts to provide for inspections (e.g., authentications) that an article is original have not solved the existing problems, hence the large authentication industry. In one case, when an authentication service was down, a backlog of baseball card authentication reached one million significantly stifling the baseball trading industry. Without the ability to verify that an article is authentic significant and may time unacceptable risk is introduced into the process.

There is also a need to verify that the individuals during the creation, authentication and transactions are who they say that they are.

There is a need to verify the location of the article, when the article was paired relevant to the event that it memorializes, what the article is, and what parties were involved with its creation and subsequent transactions.

There is also a need to verify that the actions being performed by the individual are in compliance with applicable standards, regulations and other requirements. Specifications in some processes can include the specification of an authentication process, commercialization process of other performance criteria of the article. Specifications can include initial registration and transaction requirements and notifications.

It would be advantageous to have a system that verified proper articles, authorized individuals, proper environmental and that these items and tasks are properly paired with a virtual representation. Pairing the article with a time and location at its creation, during or associated with an event, such as when it became a memorabilia item, increases the value, reduces and potentially eliminates fraud and promotes increased truth in the object and its related events and transactions. Further, pairing objects with an event, individual, team or a transaction can include immutably recording the life of the object, events, activities and transactions provides for improved ownership transfers in perpetuity.

It would be advantageous to have a system that reduced or eliminates the risk of a counterfeit, fraud, substitute, lesser quality or other non-designated or approved article being used. It would be advantageous for a system that prevented or reduced the risk of counterfeit, unlicensed or unauthorized articles. It would be advantageous to have a system that allows for third party or automated independent verification to reduce counterfeit, fraudulent, false, or misleading information and activity.

The use of inspectors can assist with reducing the risk of unauthorized articles of activities. One disadvantage of an inspection is that it occurs at a point in time after an action and cannot verify proper articles, activities, and individuals. However, the current state of the art does not allow for authentication or unique verification of the actual inspector preforming the I section of authentication. A system whereby the inspector is uniquely identified in the asset record to identify the inspector including the time, location and biometric identifier for the inspector would be advantageous. For example, in the collectible market, the inspection may occur after the event that generated the collectible so that there is no ability to completely verify that the collectible is the one that is associated with an event (e.g., the xxth homerun ball). There have been attempts to provide for automated inspection such as U.S. Pat. No. 7,508,973 which discloses a method of inspecting detects includes assigning a plurality of sets of image acquisition conditions, executing inspection using each of the sets of conditions, classifying all detected defects into real defects and false defects by use of an automatic defect classification function, and selecting, from the plurality of sets of conditions, a set of conditions ideal for detection. However, this attempt does not allow the inspector to verify that the material used and processed complies with the design and specification using a paired virtual representation.

Another disadvantage with the current system is that the data resulting from the authentications and verifications is not easily accessible by all stakeholders. This information is not immutably recorded to verify when events associated with the object occur. Also, the failure to record data immutably makes results in the data being subject to mistake, modification, alteration and/or fraud. For example, when a potential buyer is at a trade show and discovered a collectible for sale, the potential buyer has no way of easily authenticating the asset. A second buyer may be willing to purchase the item without authentication thereby placing the first buyer at a disadvantage. It would be advantageous to allow the first buyer to quickly and efficiently authenticate the time prior to purchase.

There have been some attempts to improve tracking of articles such as shown in U.S. Pat. No. 8,004397 is directed to a mountable reporting source comprising a controller coupled with an interrogating component configured for automatically receiving an identifier which is unique to an asset having a position determining component. U.S. Pat. No. 8,428 904 discloses product integrity tracking system, shipping label and associated method. This patent is directed to label body for attaching to a product to be shipped or to packaging containing the product. It does not disclose a verifiable pairing between the physical asset and the virtual representation during the article's lifetime.

It would be an advantage to have a system that can pair physical article with virtual representation so that authentication can be easily and quickly accomplished in real time.

It would be advantageous to have a system that provides for multi-party, multi-system verification of the pairing of a physical asset with a virtual representation for tracking of the physical article.

It would be advantageous to have a system that provides for a verified trustworthy association between physical material and virtual representations in an immutable record.

It would be advantageous to have a system that provides for a verified trustworthy association between physical material and virtual representations that is stored on an immutable or persistent ledger.

### SUMMARY OF THE SYSTEM

In accordance with an exemplary embodiment, this system can include a computerized system for verifiably pairing a physical asset with a digital representation comprising: a computer system disposed at a use location and in communication with a persistent storage; a physical asset having a unique identifier; a set of non-transitory computer readable instructions included in the computer system adapted for: retrieving, from the persistent storage, an origination record according to a first verification representing verification that the asset is paired with a first virtual representation stored on the persistent storage, associating significant information with the unique identifier wherein the significance information is associated with the use location and wherein the significant information is taken from the group consisting of date, time, event, team, individual, notation, and any combination, creating an asset record having the unique identifier and according to the origination record and the significance information, and, storing the asset record in the persistent storage.

Paired can include use of an immutable record that includes information such as an object, individual and transaction anchor to a location. The record can include immutable time data, biometric confirmations, unique identification of the object, and metadata from data such as images of other data associated with the object, individual, date, time, location and truncation. One form of location anchoring it is to a global position system and include the location (include geolocation) coordinates of the object, parties, and transaction. Further, specifications of the object itself could be recorded in the immutable asset record. For example, the physical material characteristics of the object, if the item has been marked in any way, the specifications of the marking device, such as an ink pen or sharpie pen, and image data that can all be immutably recorded and associated with the object or asset.

The origination record can include information of a first individual witnessing significant information and associating the significant information with the asset. For example, an official at a game can physically collect the xxth homerun ball, enter it into the system with the significant information of the xxth homerun so that the homerun ball, the asset, is digitally paired with the digital representation and the official verified that the asset and the digital representation are authentic. The origination record can include manufacturing information. The use location can be taken from the group consisting of sporting stadium, asset manufacturing facility, distribution facility, sales location, gallery, studio, IP address and any combination thereof. The location may be verified through a location anchoring using the computing devices associated with the creation of the paired asset record. For example, the GPS coordinates of the computer device can be included in the asset record. Additionally at the time of recording the immutable record can be immutably recorded, The asset record includes a shipping information received by the computer system from a shipper computer system and the shipping information includes a second verification representing that the asset received at the use location is the same asset send by an originator and received at the use location.

The origination record can include a material information representing the material used to make the asset and a manufacturing verification information representing that a manufacturer physically verified that the material used in the asset is the same material used in a design associated with the asset. The asset record can include a material information representing the material used to make the asset. The significance information can include biometric information of an individual verifying that the asset is associated with an event associated with the asset. The significance information can include biometric information of an individual using the asset or associated with the asset during an event. The event can be taken from the group consisting of a sporting event, political event, entertainment event, transaction event, signature, autograph, nostalgic event and any combination thereof. The significance information includes biometric information of an individual during a transaction associated with the asset. The significance information includes information associated with a creation of the asset. The set of non-transitory computer readable instructions can be adapted to retrieve the asset record, receive a buyer information, receive a seller information, associate the virtual representation with a transaction according to the buyer information and the seller information, create a transaction record according to the transaction, asset record and a transaction verification information. The paired asset record can have subsequent information added so that a audit trail or digital history can be immutably stored. Any event, individual, or traction associated with the object can be included in the immutable audit or history information and can include location information for each. The audit and history can include biometrics or unique identifiers associated with any party such as the manufacturer, creator, parties to a transaction and parties involved in the verification certification processes. The unique identifier of the object can be numerical or alphanumeric information, or other identifying representation as described herein that can be assigned asset number metadata from image data that can uniquely identify the asset and pairing it to the time, place, party, transaction, event and the like.

The transaction verification information is taken from the group consisting of a biometric information of the buyer, biometric information of the seller, buyer identification, verification of the seller, verification of the asset and any combination. The verification of the asset includes capturing an image taken of the asset at a transaction location, transaction date, transaction time, transaction event, buyer, seller of any combination thereof, The transaction location includes a location marker, which can be an immutable marker, associated with the location; and the computer system is uniquely paired with the transaction location using the location marker. The origination record can be created according to a physical verification of a first tag affixed to the asset. The origination record can be created according to a physical verification of the location of the asset using a global positioning system. The set of computer readable instructions can be adapted to creating a buyer record representing the buyer of the asset and storing the buyer record on the persistence storage.

Further, previous owners may be identified by wallets commonly used in the block chain or crypto currency industries. Current owner may also be identified through a wallet tied to a biometric or other known identification method. Previous and current owners could be stored in the paired asset record to ensure authenticity in a continuing ownership and or association chain of the object. When the object, asset, is sold to a new owner a new event that would record when, where, referencing the unique identification of the asset, and the parties involved who would be by metrically or other known confirmations. Recording of the series of events would ensure that when the asset or object is sold that the new owner can be assured that it is in fact the authenticated object. These assets could be sold on exchanges that were related specifically to the governing body of specific sports or event, such as the NFL or event places like Madison Square Garden.

The system can be managed and governed by an auditing function that would verify the immutable recording as well as the integrity of the data and look for anomalies to further prevent fraud or give certificates of authenticity of truth related to the item. The items themselves could be tagged or identified in a way whereby the affixing tag would be altered or changed if the tag was removed. This could be done through mechanical search circuitry whereby a unique identifier is affixed to the object and that identifier is then recorded into the asset database, any attempt to remove the identifier would change the physical or digital makeup of the identifier so that when the identifier is scanned through the immutable system in the future if the identifier has been altered it would be detected. For example, unique identification sticker could be affixed to a baseball and then the object paired to the database through a scanner on the computing device which would give a mechanical and digital signature of the identifier affixed. If that identifier is removed or otherwise tampered with the digital characteristics would be altered and can be detected, recorded and stored.

### BRIEF DESCRIPTION OF THE DRAWINGS

FIGS. 1A-1F shows various side views of aspects of the system.

FIG. 1G is a block diagram of components of aspects of the system.

FIG. 2A is a block diagram of aspects of the system.

FIG. 2B shows aspects of a user interface.

FIGS. 2C-2D show flowcharts of aspects of the system.

FIG. 3A shows an example of a communications environment.

FIG. 3B shows an example of a persistent storage.

FIGS. 3C-3D show schematics of the aspects of the system.

FIGS. 4-5 shows a flowchart illustrating aspects of the system.

FIG. 6 shows various types of biometric data that may be gathered,

FIG. 7 shows the types of events that may be triggered.

FIGS. 8-11 shows a flowchart illustrating aspects of the system.

FIG. 12A shows a plan view of a use location.

FIGS. 13 show flowcharts is aspects of the system.

FIGS. 14-22 show flowcharts illustrating steps of the system.

FIGS. 23A-23E shows schematics of aspects of the system.

FIG. 24 shows schematics of aspects of the system.

### DETAILED DESCRIPTION

The present system provides for real time verified pairing of a physical item such as collectible or memorabilia with a virtual (e.g., digital) representation that can be stored immutably. The server or kiosk can include a set of server computer readable instructions configured to receive information about an asset (e.g., collectibles and memorabilia) that can include the ability to capture information such as the description of the asset, manufacturer, characteristics of the asset such as if it us new, used, signed, unsigned, limited edition, special run, material specifications of the object and the like, an event associated with the asset such as it if is associated with a game, event, auction, and the like, its significance, or description, such as if it is a xxth home run ball, xxth win, xxth game and the like, the individuals associated with the asset such as players, teams, coaches, date and time, location, individuals that can verify or certify the generation of the digital representation and the meta data associated with that activity. Significance information can be any information that could distinguish the asset from other like assets. Significance information can include date, time, activity, event, locations, individual, team, record, notation, and any combination. For example, the event could be an end of season event, a notable event (e.g., first time to the World Series, first home run, etc.), pre-season, regular season, and the like. A notation can be an autograph, signature, label, or other addition to the asset. For example, the baseball for the 600^{th} homerun that is signed by the batter may have a larger value than one unsigned. An image of the item and those individuals associated with the event recorded in the immutable asset record. The significance information can be validated which can be performed by the system and/or one or snore individuals (e.g., inspectors) as well as verified with associated metadata.

For example, the system can capture an image of the asset, its unique identifier and associate that information with a date, time, and location. For baseball, a batter information can be captured that can include images, video, date, time, and location information of the batter. An inspector can visually inspect the asset and its association with significant event and batter and verify that the asset and individual were at the location at the same time, The system can retrieve scheduling and occupancy information and verify that the inspection and the batter were at the same location at the stated date and time. Images of the asset can be compared with environmental information (e.g., weather) information at the location, date, and time so that the background of an image showing the environmental conditions can be compared with third party weather information. If the image of the asset shows a cloudy date and the third-party weather information shows a cloudy day, the confidence of the virtual representations of the asset increases. Biometric data can be capture from the batter, creator, official, inspector or others as well as attendance information from access control system to verify that the individual were at the use location at the date and time the virtual representation is created. The location can also be verified from the location anchoring of computing devices, and the time of the event can be immutably verified and recorded against an immutable storage system such as blockchain or other chain type storage systems.

This information captured can be stored in a record that include fields associated with the above as well as make, model, quantity, warrant information, class, type, or other identification of the asset, one or more sources, the cost, care instructions, material specifications, other materials that can be included and other information. The asset information record may be updated as actual asset arrive to a location and have serial numbers, bar codes, QR codes, RFID values, beacons, lots, microdots, sizes, or other marking, identifiers or material added or associated with the asset and asset record.

For example, the material can be a baseball that was used in a game and signifies some event, such as a xxth hormone or xxth strike out or xxth hit. The original certifier can create one or more asset records representing one or more assets used during an event or process or task that can involve the asset, the location, an event, individuals, or other aspects. For example, Team 1 can be playing Team 2 and the asset can be a baseball that represented the xxth hit by Team 1 against Team 2. The baseball can also be associated with an individual (e.g., player, independent of the team such as the players xxth hit or homerun. The asset can be associated with a record or other memorialized event such a team record being broken. The associated records can be stored on a persistent storage platform that can be accessed by multiple parties. The persistent storage can be disposed at the location of the asset, event, individual, process, or assembly or can be remote from such location. For example, a stadium can have a kiosk with the computer readable instructions that can record the asset (e.g., capture an image of the asset, tag or other identifier) and the date, time, event, individual, etc. and store the information in an original asset record. The certifier or other individual can have the individual information recorded (e.g., biometric information) so that there is a record that the certifier created the record with an identifier of the asset at a certain time and location so that a record is created pairing the asset with a virtual representation.

The system can also provide the asset record to a third-party such as a retail location, auction, distributor, or reseller that can deliver the asset to a transaction location, for example for a third party such as a buyer to review and potential acquire. The third party can review the asset record and determine if the asset specified is authentic. For example, as with verification of the asset with the significance information, the transaction can be verified. Image of the buyer, seller and asset can be capture by the system and compared with third-party information such as occupancy, attendance, weather, and other information and if the third-party information is consistent with the transaction information, confidence in the authenticity of the truncation and asset increases. For example, if an access control system shows the buyer at the location when the transaction occurs, a significative event occurs of other activity so that the confidence of an authorized is increased.

The third party can be a buyer, insurance company, certifier, authentication company and the like. The asset record can be stored on the persistent storage so that the originating and subsequent confirmation and transaction information cannot be subsequently altered or tampered with. The asset record can include a virtual representation of information associated with the physical asset. In one embodiment, the asset can be specified by class, type, product code, product number of other identifying information and virtual representation so that the material requirement record includes the asset paired with the virtual representation which is verified by the certifier. This verification is independent of the other verifications described herein.

The asset record can include manufacturing place, warehouse site, shipping information, transaction information or other information showing that the life of the asset. For example, the asset record can include the manufacturing location, serial number, date shipped, and date recited at a stadium. The asset record can include when the asset was used (e.g., in practice, during a game, etc.), the location where the asset will be used and what the asset will be used for. For example, for significant sporting events, there can be customer equipment used. In the United States, the Super Bowl can have specific game balls that are design and used specifically for the end of season game, When one or more asset records are included on the persistent storage, along with the other records described herein, an audit trail can be created that is based upon the collection of records on the persistent storage.

When the asset is selected for transport by the manufacturer or supplier, a shipping company can be sent a shipping order representing the asset to be transported. The shipping order can include the verifiably paired virtual representation and its information. The shipping company can be provided shipping information from the manufacturer, designer, supplier, or other company that can facilitate the transaction (e.g., broker, distributer, reseller). The shipping order can be provided directly to the shipping company or can be retrieved from the persistent storage. Once the shipping company receives the shipping order, it can travel to the desired asset location and determine if the asset in the shipping order match the physical asset at the desired location. A shipping pickup record can be created representing that the shipping company received the asset and that the asset picked matches the shipping order, This verification can be independent of the other verifications described herein. The verification can also be used by a smart contract associated with the shipping of the object and shipping record.

Once that asset is delivered to the desired location, the shipping company can unload the asset and verify that the asset that was unloaded was the same asset included in the shipping order. This can occur through autonomous computing systems that scan and compare and analyze the unique identification numbers as well as the originating location and time to the corresponding delivery time and address data and using analytics verify the probability of certainty that the item could have been transported. Mechanically driven scanners and verification processes could also be utilized. The immutable data asset record could be then updated autonomously or through input devices. The shipping company can create a shipping delivery record representing that the asset was delivered and that the asset matches the shipping order. The shipping record can include the environmental conditions when the asset was delivered, delivery notes and the like. The shipping delivery record can be stored on the persistent storage. Receiving entity can review the asset delivered and verify that the delivered asset matches the design, asset requirements, supply record, shipping order, shipping pickup record, shipping delivery record of any combination.

Once the asset is received by the desired location, the system can notify individuals that the asset is ready for use. The individuals can be verified by the system and an individual verification record can be created and stored on the persistent storage. The system can utilize biometrics or other systems as described herein for verification of actual individuals at the physical location confirmation to correspond with requirement for those that can verify that the asset if authorized. For example, in some sports the game balls are inspected for attributes such as proper material, unauthorized modifications, inflation and the like. In one sport, the inspection requirements include a certain individual hold a game ball until 10 minutes before the game start. Each team must supply 24 balls to the official's locker room two hours and 15 minutes before the game. The current system can verify that the balls record matches the balls that were used adding an additional layer of verification. Further, the history of the asset can be known from manufacturer to game use. The immutable time record along with the immutable location record and the object identification can be used for authenticity confirmation.

The system can identify individuals entering or leaving the asset location and store this information on the persistent storage. The verification can be through biometric identification devices such as a camera or other image capture device, facial recognition, voice recognition, retinal scans, fingerprint scanners, hand scanners, and other biometric devices. In one embodiment, the computing logic may avow authorized individuals to manually enter the presence of another authorized individual, including on the controller at the use location or through a remote device that can be determined to be at the use location, within a boundary associated with the use location, in proximity to the system. In one embodiment, individuals may be verified and paired with a virtual representation using two-factor authentication.

The individual can be provided with user information and specifications or other design requirements that can be represented by a task record, The task record can be stored on the persistent storage. Once installed the system can verify that the asset was used (which can be individually inspected) according to the task record, create a task verification record and store the task verification record on the persistent storage. The task verification record represents that a task associated with the asset was properly completed. The task record can represent that the task was performed by proper individual and in compliance with any requirements as well as if the asset passes one or more inspections.

Prior to, during, and after a task is completed, an inspection can be performed that can include a pre-task inspection, task inspection, post task inspection and any combination. A pre-task inspection, task inspection, and post task inspection record can be created so that the three records can be stored on the persistent storage. The task record can include information that the inspection resulted in passing, passing with deficiencies, and failing. If the inspection fails, the official, team, participants or players or other entities can be given the opportunity to remedy the failure and the inspection process can be performed again. The process can also determine if, while the task passed the inspection, the deficiencies should be remedied.

The system can be uniquely associated with the use location. A location marker can be affixed to the user location and uniquely identify the user, object, event, or other relevant data origin location. The use location can be an event location (e.g., stadium, arena, track, school, gallery, manufacturer, distributor, etc.), auction, trade show retail shop, business, and the like. The location marker can be read by the system so that the system can determine its location. Third parties can read the location marker to determine the location. For example, the shipping company can arrive at the manufacturing location, read the location marker, and associate the location marker with the receipt and shipping of an asset. In one embodiment, the manufacturer can receive a shipping identifier associated with the delivery, such as a truck, trailer, pallet, or other container so that the asset is known to be received at the user location. Other parties can also access the location marker to verify that the third party is at the use location. Such access can be through hardware communications which as LTE, 5G, Bluetooth, WiFi, and other wired and wireless communications. Information can be captured form personal devices of individuals including device ID number, date, time, locations, and the like. Such device information can assist with a determination of when and where an individual was at a time of an event or transaction. This information can be immutable recorded and associate or included in the asset record.

The system can be contained in a housing such as a kiosk and can be physically associated with the use location. The use location can be defined by a boundary representing the perimeter of the use location. The system can include a sensor and reader which can be selected from the group consisting of radio frequency identification (RFID) detector, ultra-high frequency (UHF) detector, a bar code scanner, a QR code scanner, near frequency communication (NFC) device; Bluetooth beacons, an optical character recognition (OCR) device and any combination thereof. An environmental sensor, such as a weather sensor or weather station, can be in communications with the or included in the housing and configured to record the weather and other environmental conditions at the use location and at different times during the project. This information can be used to verify the authenticity of the asset.

The system may record the date and lime of events such as the arrival and departure of asset, individuals, player, audiences, participants officials, third parties, inspections, and the like to and from the use location, the date and time associated with environmental conditions including weather. Recording environmental information, including weather, at the use location allows for autonomous confirmation of environmental conditions that do not rely solely on third party sources or sources that are general or distant from the use location. For example, if an asset record is associated with a particular game the environmental condition of that event can be recorded so that subsequent authentication can match the purported event location, date and time and weather conditions at that location, date and time to determine if there is a match.

The system may also determine if an unidentified individual attempts to enter the use location, the system may take the appropriate responses, such as sending notifications, triggering alarms, and/or contacting law enforcement authorities or security. The decision as to the appropriate response may be determined by, the date, the time, current weather conditions, authorizations, project or process status, or related factors. This functionality of the system can prevent the loss of asset such as a jersey, game ball or other article from being taken without authorization.

The smart locks may also be used to limit access to certain portions of the use location. An individual's right to a specific asset may be dictated by permissions that are stored through each party involved in the process. This may eliminate keyed entry during the process and provide further verifications of individual or group access. For example, once a game ball is provided to an area reserved to officials, no other official may be allowed to enter the area where the game balls are stored.

The individuals on the use location may be prompted to wear certain wearables that provide useful information to the system. For instance, individuals may be prompted to wear location tracking devices, such as GPS devices, Bluetooth, radio frequency identification (RFID) devices, ultra-high frequency (UHF) and/or beacon-based devices. The use of the wearables helps to perform geofencing within the use location. The location tracking provided by the wearable helps the system to monitor the location of individuals on the use location on an ongoing basis. The permissions may define what portions of the use location an individual may access. Ongoing monitoring may indicate that an individual is attempting to enter a location where the individual is not permitted. This may trigger a response as described herein. A signal may be sent to the vest or wearable to trigger a visual or audio cue that the individuals not in a permitted area. In addition, individuals may be requested to wear wearables that track biometric information, such as heart rate, body temperature, respiration rate and blood pressure. This information may be tracked and stored on an ongoing basis.

The system may track the movement of assets at the use location or to and from the use location. Scanning technology such as RFID readers, UHF readers and/or the like may be utilized to assist the location tracking of assets and even individuals. The tracking of asset helps reduce the risk of loss, theft, mis-delivery, and the like. For example, the tracking solution may indicate instances of possible theft, such as when the asset is leaving the use location when the removal of the asset is not proper. Tracking can improve the confidence in the authentication of the asset. Items with significantly higher values might have constant tracking to ensure their authenticity.

The system may allow for the establishment of one or more geofenced zone that can be associated with use location and location of the asset. These locations can include entrance areas, exit areas, event areas, storage areas, and any combination thereof. These areas could be monitored and established with access allowances or restrictions to control movement of assets, individuals, and equipment to assist with the prevention of loss, mistakes, fraud, theft, inefficiencies, and damage. The system can assist with verification that asset stored at these locations are consistent with the information concerning the asset status, locations, state, etc.

The system, including a controller, may also interface with individuals to allow for the entry of notes and related details of a material, task, inspection, environmental condition individual, other task, process of individual or any combination thereof. For example, the system may allow an inspector to capture images of notes, forms, documents, labels, and the like using various readers, sensors, and input devices. The system can capture the use of the asset such as during a game, on the sideline, etc. Event and occurrences that can ass significance to the asset can include foul balls, homeruns, wins, loses, records (e.g., xxth hit), plays and any number of events or occurrence that are associated with an asset.

Smart contracts may be provided that use the persistent storage for each event of the asset is transferred the ownership and payment can execute upon satisfaction of terms of a transfer event. For example, when an asset is delivered from a shipper to a use location and a verification of the asset with is virtual representation occurs, this event can trigger a smart contact that instates payment to the shipper, When the asset is transferred from one owner to another, the system can recognize the transfer, update the asset record with new ownership or custody change, record the transaction, and automatically initiate payments or other funds transfer. Smart contracts can be used to create a digital asset that can be valued and traded itself. For example, the digital representation of a player signed in xxth baseball can be a digital asset, have its own independent value, be subject to verifications (e.g., capturing date, time, location, individual, IP address and the like), subject to the verification herein and stored on the persistent storage similar to an asset described herein. For example, a digital photo of an event (e.g., player signing a baseball) can be captured and that digital photo can be the asset. Photos of significant occurrences at an event which might not include any other physical object than the participant can become an asset. The photo could include GPS anchoring in the metadata time verification through block chain or other persistent storage hashing biometrics of the originator as well as biometrics of the subject of the photos. These photos could be authenticated and given asset number which would prove originality, prevent re-, or copies.

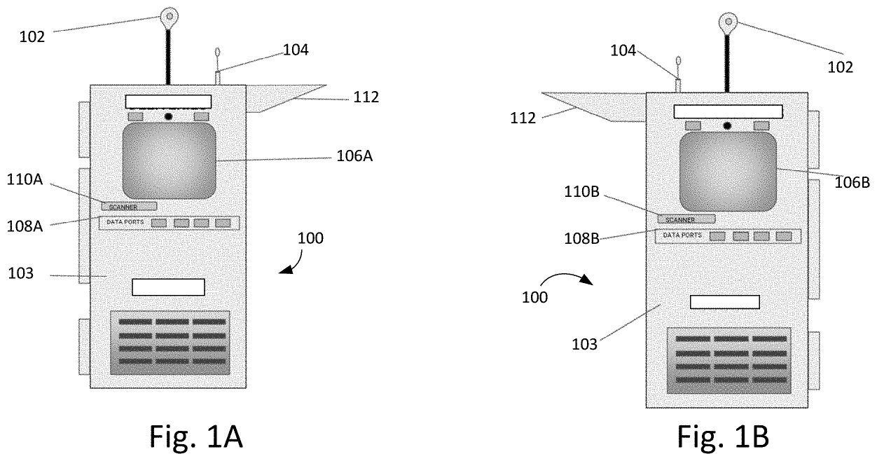

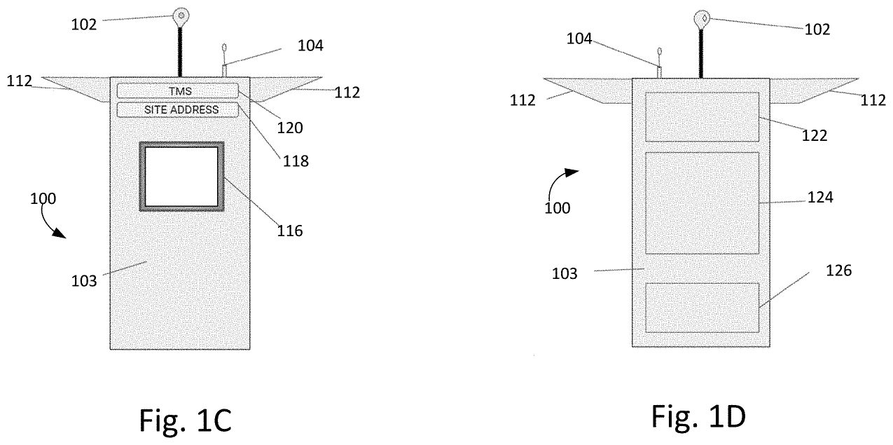

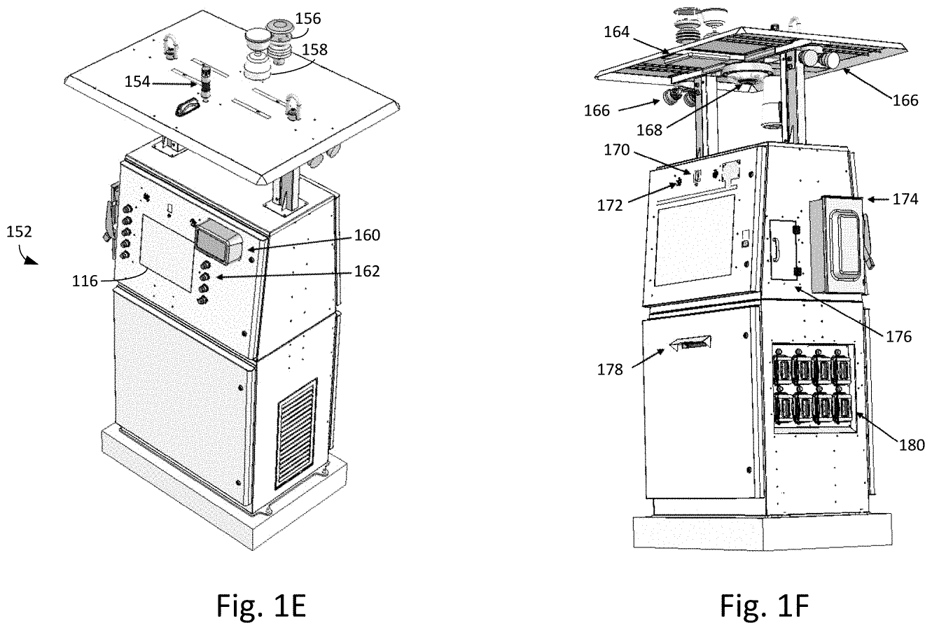

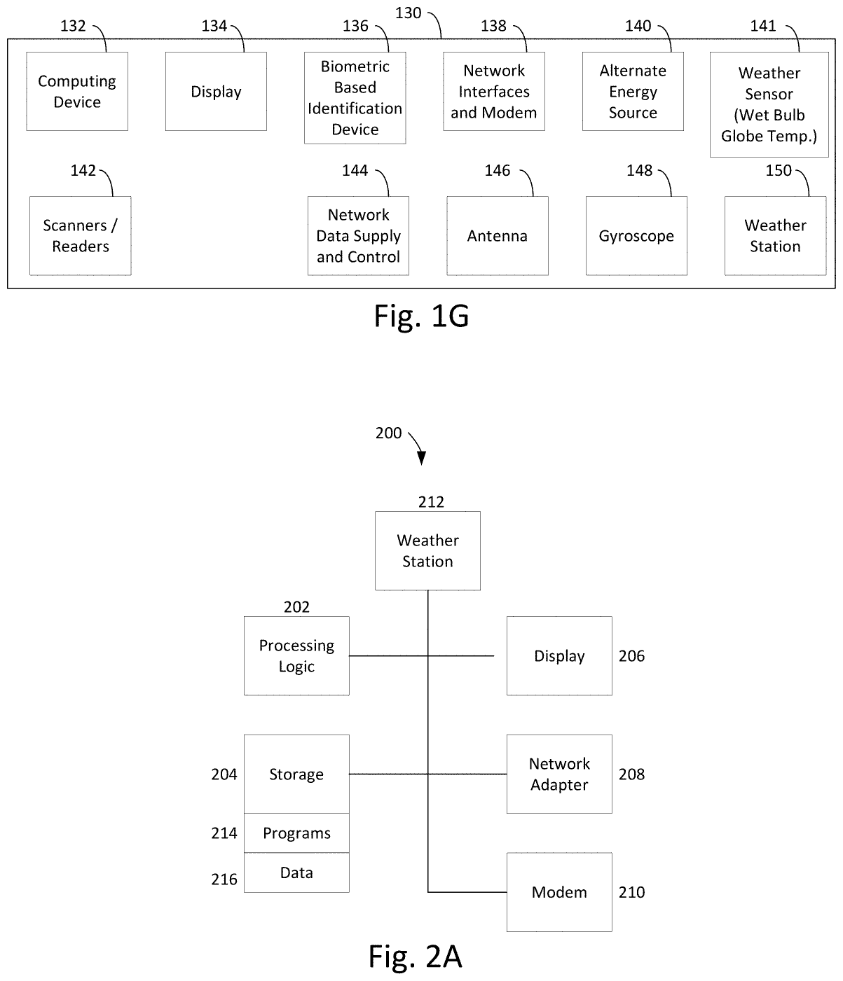

FIGS. 1A-1D illustrate an example of a system 100 that can be a kiosk of other housing that can be uniquely associated with a use location in an exemplary embodiment. The housing can be a housing that can be affixed to the use location. In FIGS. 1A-1D, the system is implemented as a kiosk that can be mobile and include a housing having a controller. The housing 103 may be located at a use location and include a controller in communications with a computer readable medium. The housing can be physically associated with the use location, virtually associated with the use location or both. A location marker can be affixed to the use location such as in a concrete slab or otherwise affixed at the use location. The housing can be removeable attached to the use location so that it is stationary during a first project or process but can be moved to a second project or process at a different physical location once the first project or process is completed. For example, the housing can be positioned at a trade show for collectibles or memorabilia transactions during that trade show and removed at the conclusion of the trade show.

For a location marker, in one embodiment, a transmitter such as a RFID can be associated with the use location by embedding it is a permanent fixture. The system can read the information from the location marker and associate its actual location with the use location. The location marker can include an alpha, numeric or graphical information such as a number, letters, barcodes, QR code, physical, plaque, sigh or geographic coordinates (e.g., GPS coordinates), passive transmitter, active transmitter, and the like. Each system can have a unique identifier and each use location can have a unique identifier.

FIG. 1A shows a first side of the system 100. The system 100 can include a camera 102 for obtaining images of assets, individuals, or other items at, entering or leaving the use location as well as images of individuals along a perimeter. The camera 102 may capture biometric images upon which biometric recognition may be performed. Multiple cameras may be placed on or around the housing. The cameras may have biometric recognition and motion detection capabilities. System 100 may include an addition to the camera 102 or instead of the camera 102, biometric-based identification devices that may be used to confirm the identity of individuals entering, leaving or on the perimeter of the use location. The system 100 may include an antenna 104 for communicating with a network including a wireless network, Wi-Fi network, Bluetooth, quantum networks, cellular network (e.g., 4G or 5G network) and any combination. The system 100 may include a housing 103 made of suitable weather resistant material, appropriately sealed to protect the internal hardware, The system 100 may include a display 106A, such as a touchscreen display, upon which information may be displayed and entered. The display 106A may include an integrated camera that may be used to capture images and that may be used in performing facial recognition of individuals. The display may also include or operatively associate with one or more integrated speakers for providing audio output, a microphone for receiving audio information to facilitate two-way communications to a remote location. The system 100 may include a scanner 110A for scanning items, such as deliveries, as will be explained in more detail below. The scanner 110a may be, for example, a OR scanner, an Optical Character Recognition (OCR) or a bar code scanner 110A in some instances. The side of the system 100 shown in FIG. 1A can be used for deliveries and inspections. A delivery person may scan delivered materials, equipment, or other items via the scanner 110A and may interface the system using the touch screen display 106A. An inspector may scan or take images of inspection documents via the scanner 110A or camera and may interface with the system using the touch screen display 106A. In some embodiments, there may be fewer sides in which to interact with the system for all authorized personnel. An overhang 112 may be provided to assist in decreasing glare and protecting some of the items on the housing from the weather. The above components can be included in a sensor assembly in communications with the controller.

FIG. 1B depicts a side of the system 100. This side can include a touch screen display 106E as well as a scanner 1148. Display 106E may include or be operatively associated with an integrated camera for capturing images, speakers for providing audio output and a microphone to facilitate two-way communications with a remote location. Still further, this side of the system 100 may include data ports 108B,

FIG. 1C shows a third side of the system 100. This side has a location 116 in which information such as certificates, bill of sale, receipts, tax information, and the like and may be displayed. In some embodiments, the information displayed may assume electronic form so that a video display is provided in the area 116 of the housing 103, In one embodiment, the unique identifier can be a number 120 for the use location may be displayed on the housing 103. Other location identifying information can be displayed such as location number, store number, assembly number, trade show number, certification number, use location and the like. In addition, the site address 118 may be displayed on the system 100, The site address may refer to both the mailing address for the use location and/or other physically identifying information associated with the location.

FIG. 1D shows a side of the system 100. An access panel 122 may be provided to access a breaker box for the system 100. An additional access panel 124 may also be provided to access internal components of the system 100.

Referring to FIGS. 1E and 1F, the housing 152 can include a side that is configured to be used by an individual at the use location. The housing can include an alarm indicator 154 that can be actuated as described herein. The housing can include a weather station 156 that can include an integrated or separate fluid (e.g., rain) collector 158. Biometric reader 160 can include an iris scanner, fingerprint scanner, palm print scanner, facial scanner, or some combination. Display 116 can be proximity to input assemblies such as buttons 162. The housing can include a field receiver 164, lights 166 and camera 168. One or more cameras can provide a 360° field of view and include a wireless connection for transmitting images to a remote computer device. The images can also be inputted into the system including input allowing the system to identify delivered materials and/or objects. In the instance of registering photos is a pair digital asset this might be used to recognize an individual, photographer, entering the field. The system can include one or more second cameras 170 such as webcams disposed at various locations around the system for capturing images. The lights can include motion activation and photoelectric activation. Speakers 172 can be included to provide audio information to a user, inspector, or other party using or near the system. The audio information can include instructions, alarms, and the like. Power junction 174 can include a shut off switch that can be used in emergency and non-emergency situations. The system can include a secondary power source, such as a battery, so that when the main power is shut off, an alarm can sound, notification send to a remote computer device of other indication that the system or power source has been powered down. The system can include a hand scanner (not shown) that can be protected by a hand scanner access door 176. A document scanner 178 can be included in the system for receiving physical documents, converting the physical document into a digital representation, and storing the digital representation on the computer readable medium or the persistent storage.

FIG. 1G depicts components that may be included in the system of exemplary embodiments even when not included in the housing. The system may include a computing device 132. The computing device 132 may take many different forms indicating a desktop computing device, a laptop computing device, a mobile computing device, an embedded system, a smartphone, special computer device, custom computer device, or the like. A display 134 may be integrated with the computing device 132 or as a separate device, such as a liquid crystal display (LCD) device, a light emitting diode (LED) display device or other types of display devices on which computer information may be displayed. One or more biometric-based identification devices 136 may be provided. As will be explained in more detail below, multiple biometric-based identification devices may be used. Network interfaces and a modem 138 may be provided. The network interfaces may interface the computing device 132 with a local area network or a wide area network wherein the networks may be wired or wireless. A transceiver or other communications assembly can be included allowing communications with remote computer devices. For example, when an object is used during an event such as the xxth homerun, a portable computer device that has its own location information and is associated with this system and kiosk, can be used to record the object, event, individual, date, time, location and other data described herein to create a record that can be immutably stored. The system can be a portable computer device that can be assigned to a location during the transaction of other activity associated with the object or asset.

The system 130 may be implemented in a distributed fashion and may include an alternative energy source 140. For example, solar panels, wind turbine(s), a battery or the like may be used. In one embodiment, the alternative energy source may be physically affixed to the housing or in communications with the system or controller. For example, solar panels or a cable to a wind power source could be configured to provide power to the system and/or can be affixed to the system or housing. Alternatively, a power line leading to the alternative energy source may be connected to the housing and system to provide power to the system, housing, and associated components such as external power supplies.

The system 130 may include various scanners and readers 142, such as those described above relative to housing. The system 130 may include an Internet data supply control 144 and a mechanism for turning the access to this service on and off under a programmatic control. Programmatic control may be provided to grant or deny access to such resources. The system 130 may include an antenna 146 for wireless communications signals to receive and transmit. The system 130 may include a gyroscope 148 to monitor any moving of the system. The gyroscope 148 may indicate motion indicative of whether someone is trying to move or tilt the housing or other components of the system. Logic may be provided to send a notification in such an event where the gyroscope indicates substantial enough movement. The system 130 may include a weather station 150 to measure current weather conditions, such as temperature, air movement, humidity, precipitation, barometric pressure, direct sunlight, and the like. Input from the weather station 150 may be used to inform decision making by the system in some instances. Alternatively, the weather may be collected via software, such as from a weather service or other weather source. Similarly, the system 130 may include a weather sensor 141. The sensor can be a wet bulb globe temperature adapted to measure, among other things, heat stress in direct sunlight, which accounts for temperature, humidity, air movement (direction and speed), sun angle and cloud cover (solar radiation). This data can be part of the event or object and associated with the asset record.

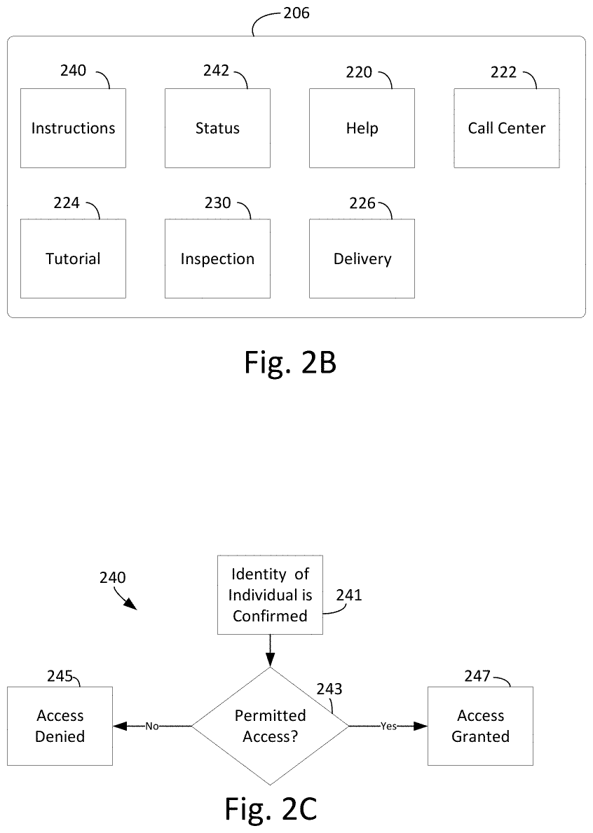

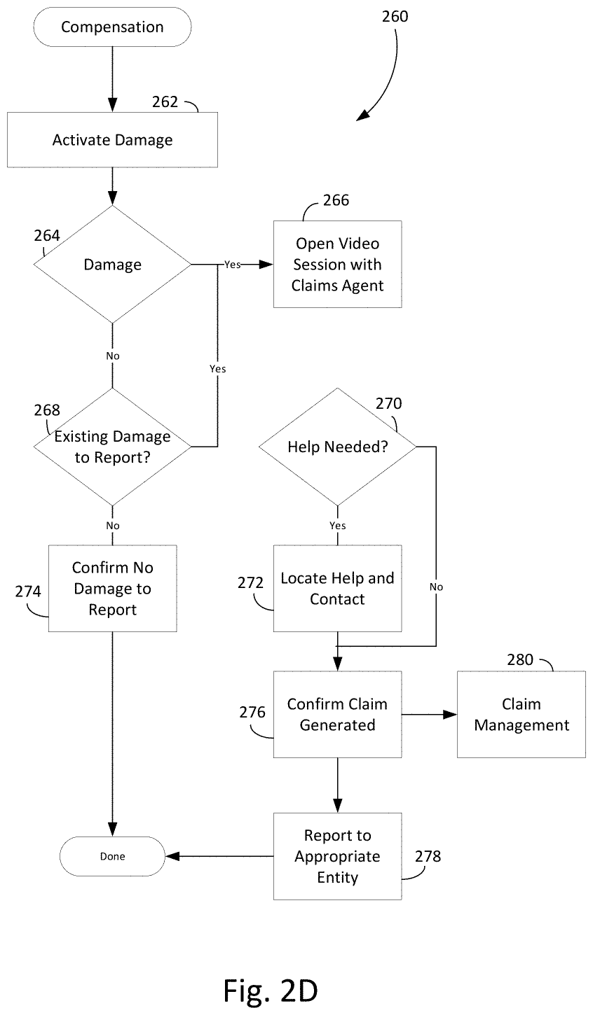

FIG. 2A shows an example of a computing device 200 for the system. The computing system may include processing logic 202, such as microprocessors, controllers, field programmable gate arrays (FPGA), application specific integrated circuits (ASICs) electronic circuitry, and other types of logic. The processing logic 202 performs the operations of the computing device 132. A storage device 204 may also be provided. The computer readable medium and/or data storage device 204 may take various forms, including magnetic storage, optical storage, etc. Storage capability 204 may include computer-readable media, including removable computer readable media, such as disks, thumb drives and the like, or disk drives, solid state memory, random access memory (RAM), read only memory (ROM) and other types of storage. The computing device may include a display 206, such as an LCD display, an LED display, or other types of display devices on which video information may be displayed. The computing device 200 may include a network adapter 208 for interfacing with networks and a modem 210 for communicating wirelessly, over telephone lines or cable lines with remote devices. The processing logic 202 may use information stored in the storage device 204. In particular, the processing logic 202 may execute programs 214 stored in the storage and may access and store data 216 relative to the storage device 204. The computational functionality of the system described herein may be realized by the processing logic 202 executing the programs 214,

FIG. 2B shows an example of a user interface on display 206, such as found in the housing 100. The user interface may include activatable elements. A user may depress these activatable elements or select these activatable elements using an input device, such as a mouse, keyboard, touchscreen, or the like, to activate the components. The display 206 may include a help element 220 that may be activated to obtain help information regarding use of the housing. It may also contain real time project or process plans. It may also include “how to” assistance including videos related to the various projects, stages, processes, and tasks performed at the use location. The user interface on the display 206 may also include a call center activatable element 222. Selection of the call center activatable element 222 may cause a call to be initiated with a call center so that the individual using the system 100 may have a telephone and or video conference with personnel at the call center. The call center can be connected to several third parties including a prior authentication individual or entity in the event that communications is needed. For example, a call can be made as a trade show to a stadium to verify or assist in the verification of an asset and if that asset originated at the stadium. The user interface on display 206 may also include a tutorial activatable element 224. Selection of the tutorial activatable element 224 causes a tutorial to be displayed to teach the individual about operation of the housing.

Referring to FIG. 2C, the display may show instructions 240 for completing certain tasks or other information. A status of tasks and assets can be displayed at 242. For example, an individual can view the display and receive status information about assets such as anticipated delivery, route information, current location, or tasks as well as the status of tasks including performance steps, start times, competition times and the like. The identity of an individual can be confirmed at 241, such as described above using biometric identity verification. The individual's information is accessed to determine if the individual is to be granted access to the asset at 243. If the permissions indicate that access is to be granted, access is granted 247. In contrast if the permissions indicate that access is not to be granted, then access is denied 245. Permission information can be included in the individual information record. Permission information can be retrieved from the persistent storage or the system.

Referring to FIG. 2D, if there is damage or loss of an object at 262, a loss of claim can be made at 264, a video session with a claim agent associated with anyu insurance on the object and can be initiated at 266. The claim agent may gather information to initiate any claim processing. The claim agent may determine if assistance is warranted 270. If assistance is warranted, the location of appropriate help can be identified based on a location of the use location (e.g., based on proximity and type of injury) and contact is made with the assistance 272. A confirmation of the claim can be generated 276 and sent to claims management 280. In addition, a report may be sent to the appropriate entity or authority at 278. The steps 266, 270 and 272 may also be performed in the instance in which the individual has an older injury to report 268. Where there is no injury to the individual, the lack of injury is reported 274.

Shipping or delivery company personnel may activate the delivery activatable element 226 (FIG. 2B). This causes a delivery functionality to be displayed where delivery notes may be added and where information may be gathered from the delivery person regarding a particular delivery, Objects that might later become paired digital asset could be registered upon their delivery to the specific location. Also relevant to the time they were delivered and their eventual use and memorabilia creation event. This improves authenticity of the asset by providing a delivery time and location. For example, if a baseball was delivered on a first date but the asset record reference a second date, an auditing engine could recognize the anomaly and provide the appropriate record and notifications.

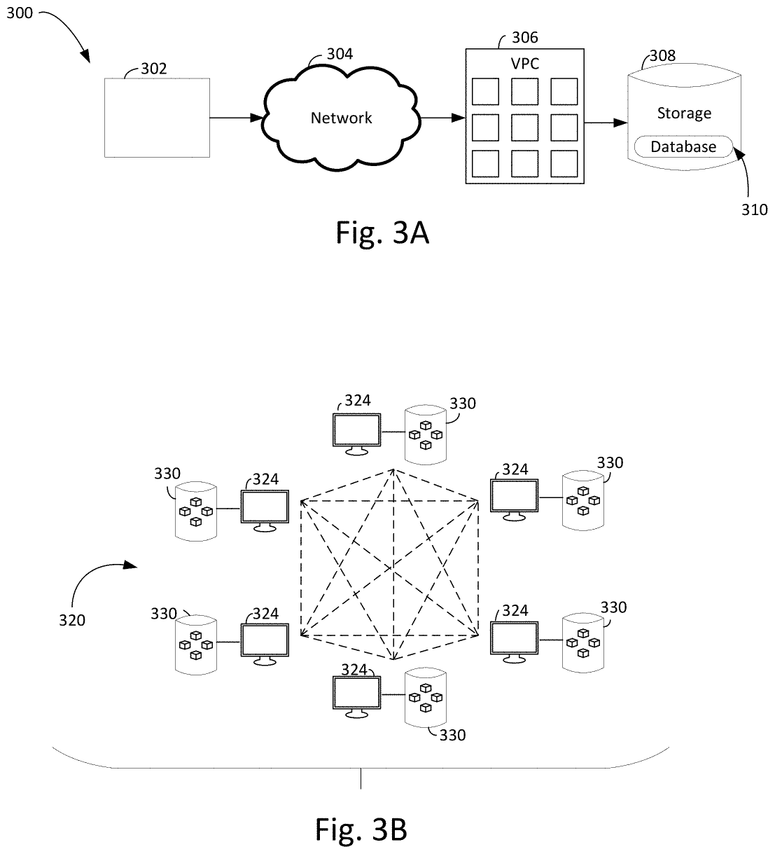

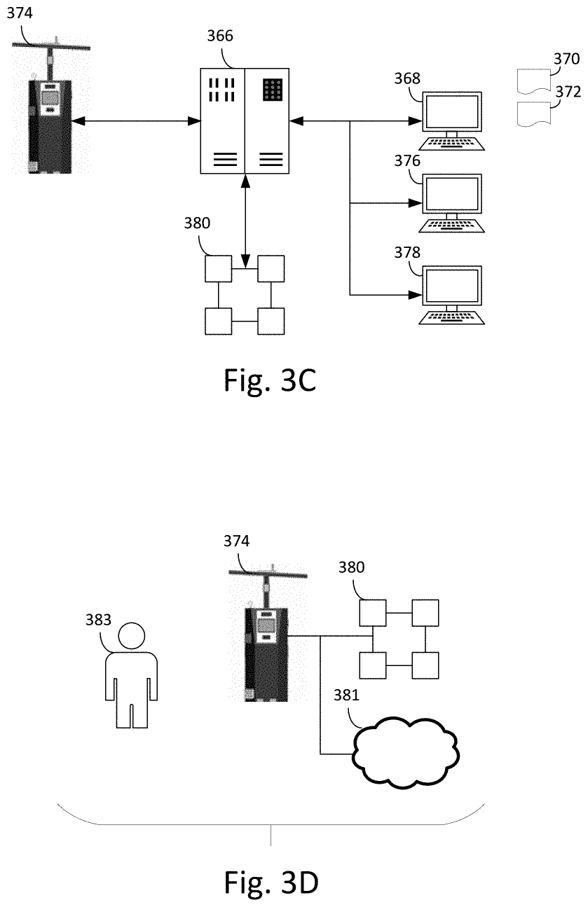

As shown in FIG. 3A, the exemplary embodiments may be implemented in a decentralized computing environment 300, that may include distributed systems and cloud computing. FIG. 3A shows one or more systems 302 that may be in communication with a remote cluster 306 via a network 304. The cluster 306 may store information received from the system 302 and provide added computational functionality. The network may be a wired network or a wireless network or a combination thereof. The network 304 may be a secure internet connection extending between the system 302 and the cluster 306, such as a virtual private cloud (VPC). The server may be a computing device and can be in communications with the site computer device. The cluster 306 may include access to storage 308. The storage 308 may include a database 310 in which information regarding a use location is stored in a consistent manner.

FIG. 3B shows diagram 320 of an example of a peer-based network where a persistent storage 330 is broadcast and shared among the nodes 324. This network may be resident in the VPC cluster 306 (FIG. 3A) or in the network 304 for example. The nodes 324 may represent computing resources, such as server computer systems or other computing systems with storage devices 330. FIG. 3C shows a kiosk 374 in communications with a server 366 that can be in communications with a distributed network 380 or computer, storage devices of any combination. Third party computer system 368, 376 and 378 can be in communications with the server 366 and kiosk 374 so that information 370 and 372 can be shared with these systems. FIG. 3D shows a user 383 using a kiosk 374 to access information from distributed storage 380 as well as transmit and receive data from a global communication network 381.

The information from a manufacturer, supply company or other third party can also be stored on the persistent storage and retrieved by the system. The controller can be configured for receiving an asset record from the designer representing the asset, creating an actual asset requirement record for the project or process representing the actual asset delivered to the use location by a supply company, creating a final asset record according to a difference between the asset requirement record and the asset material record, receiving receipt verification information representing the actual asset was received by an authorized individual.

Processes, projects, and task specifications, which may be needed for compliance with warranty, insurance, design, specifications, inspection, and other requirements, can be received at 376 and requirements can be received from a requirements computer device 378 either directly or from the persistent storage. The requirements can include approved materials that are approved by regulatory entities, such as governments, leagues, manufacturer, teams, players, designers, and the like. Requirements can include specifications, materials, safety codes, and individual licenses, and the like.

The various computer devices, including the server and site computer device (e.g., system, controller, and any combination), can be in communications with persistent storage 380. The persistent storage can include a distributed ledger, immutable database, block-chain structure, and the like. The communications between the various computer device, including the server and the site computer device and persistent storage can be a global communications network, wide area network, or local area network, delivered to a computer readable medium from one device to another (e.g., USB drive, CD, DVD) and can be wired or wireless.

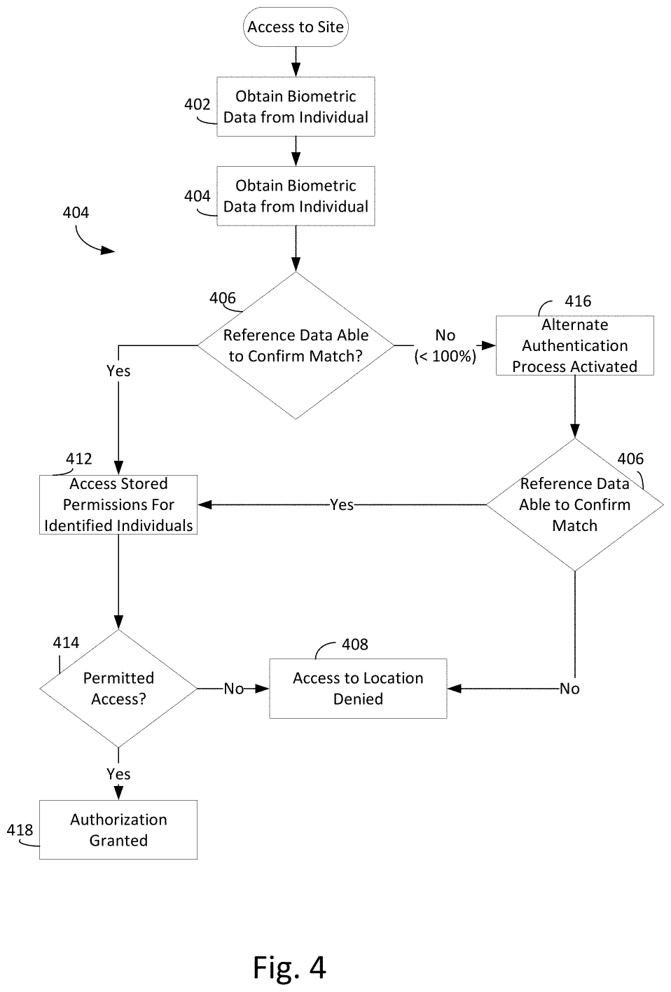

FIG. 4 shows a flowchart 400 identifying steps that may be performed in exemplary embodiments regarding this functionality of the system. Initially, biometric data is obtained from an individual or other individual that is seeking access to the use location 402. In some exemplary embodiments, a camera 102 may capture an image of an individual and facial recognition may be performed. The biometric data in one case is the facial image of the individual. hi other exemplary embodiments, the biometric data may be, for example, fingerprint data, hand scan data, voice print data, retinal scan data or the like, gathered by appropriate biometric-based identification devices. The obtained biometric data is stored, and then previously stored data is accessed from storage to compare biometric data for known individuals and to attempt to identify the individual 404. A comparison may be made between the gathered biometric data and the known biometric data to determine if there is sufficient closeness for there to be a match. Information regarding the identity of the individuals for which the biometric data is stored is also stored in the storage device. A determination is then made whether there is a match or not 406.

If there is not a match 406, a manual process may be executed, or an alternative authentication process may be deployed 416. If this alternative authentication fails to produce a match 406, access to the use location may be denied or the individual may not be able to authenticate an object or event at 408.

The system may store permissions for each individual accessing the use location. These permissions may identify the dates and times where the individual is given access to the use location. In addition, the permissions may specify what assets and actions the individual can access or preform. These permissions may be accessed to determine the permissions for the identified individual 412. If the permissions indicate that access is permitted 414, the individual may be granted access to the use location and/or asset at 418.

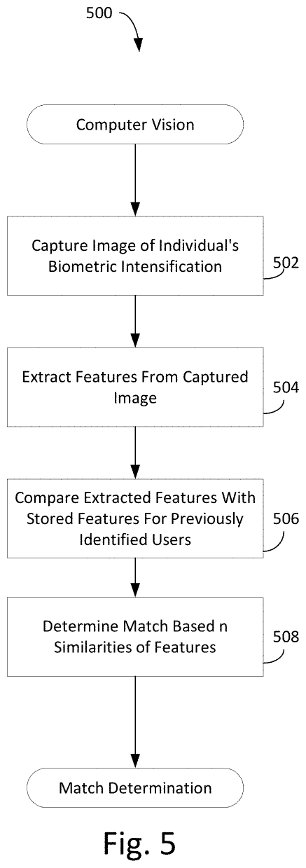

FIG. 5 shows steps that are performed in a case of computer vision for 402, 404 and 406 of FIG. 4. The flowchart 500 begins with 502 in which an image of an individual is captured for biometric recognition. This may be captured by a number of different types of image capture devices, including an intermittent video camera, still camera, iris scanner, facial scanner, fingerprint scanner, or other type of capture device. In the case where an image of the face of an individual is captured, identifying features may be extracted from the captured image 504. In other words, unique facial features that help to identify an individual are extracted from the image. The image may be filtered and/or normalized. The features are then compared with the stored features for identified individuals 506, determination is made whether there is enough similarity for there to be a match.

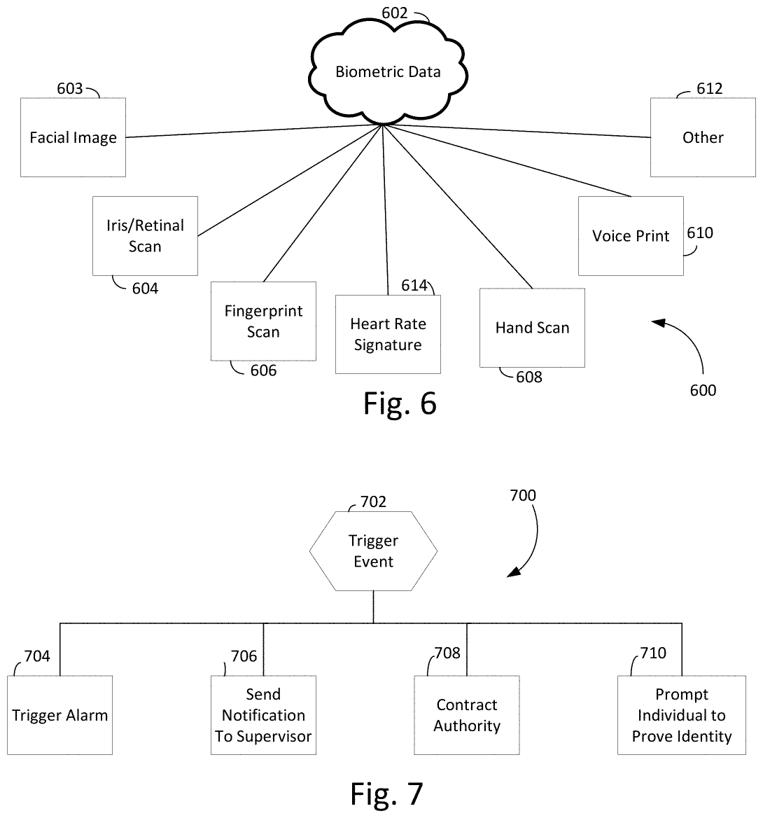

FIG. 6 shows a diagram 600 that illustrates various types of biometric data 602 that may be obtained by biometric-based identification devices at the use location to attempt to identify individuals. Biometric data may include facial recognition 603 an iris/retinal scan 604, a fingerprint scan 608, a hand scan 608, a voice print 610 or heart rate signature 614. It should be noted that other types 612 of biometric data may also be used in exemplary embodiments to help identify individuals uniquely. Also, an individual may be required to provide multiple types of biometric data in some instances.

When individuals attempt to access the system and is not granted access, certain events may be triggered (see 410 in FIG. 4). FIG. 7 shows a diagram 700 that provides an example of different types of triggered events 702. One type of triggered event is an alarm 704. This alarm may include visual alerts, audio alerts and any combination thereof. The alarm may be a silent alarm to individuals. Another event that may be triggered is to send notifications to a supervisor for the use location 706. The supervisor may, for example, receive an email, a text, a phone call, or another notification that someone is trying to access the site that is not permitted. A triggered event 702 may also include the contacting of law enforcement or a member of a security service indicating that an unauthorized party has tried to access the use location. Lastly, a triggered event 702 may include prompting the individual to produce proper identifying information to an official at the site or to a scanning device at the housing 100.

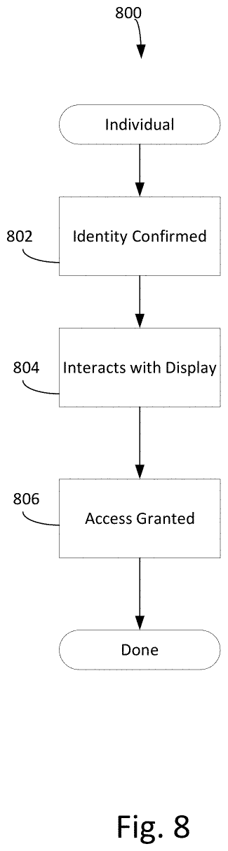

FIG. 8 shows a flowchart of the steps that may be performed to ensure that an individual gains access to the appropriate items once they have been granted access to the system. As shown in the flowchart 800 of FIG. 8, initially the individual has their identity confirmed, as has been discussed above 802. The system may offer an alternative touchscreen option to place a call to the appropriate party should the software fail to verify and otherwise authorized the individual. The individual may be prompted to interact with the display, such as the touchscreen 106B (FIG. 1) to register and to indicate whether they seek certain items.

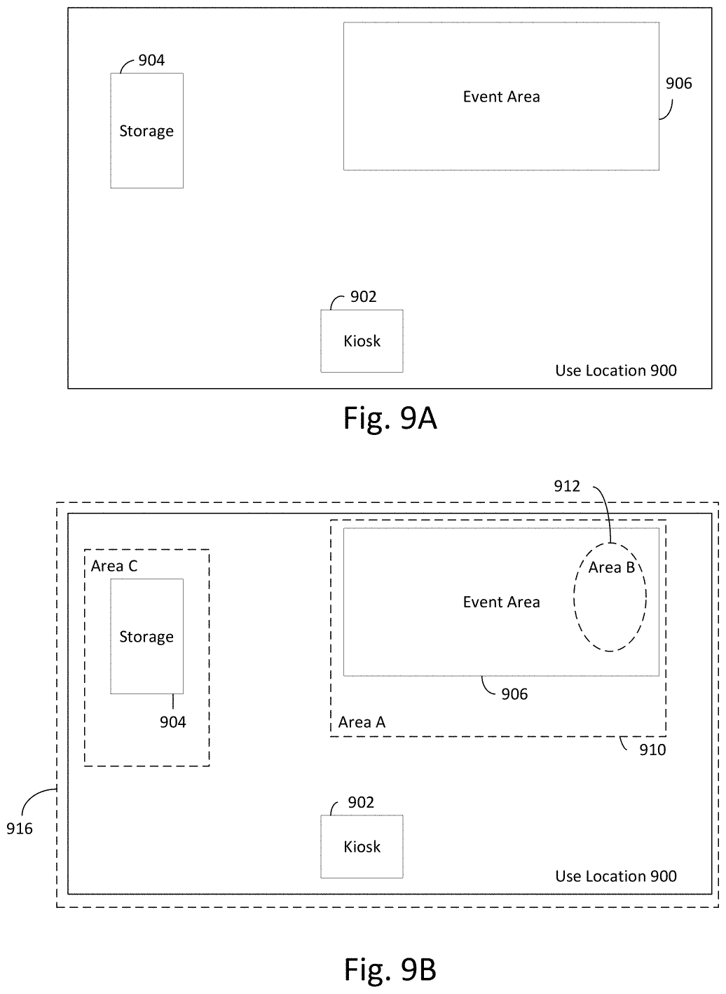

To help illustrate an example of geofencing, FIG. 9A shows an illustrative use location 900. The use location 900 may include a housing 902 for the system as well as storage location 904 that can be a building, trailer, shed or the like. The storage location 904 may hold assets which can include sporting equipment unused or used during an event and/or materials. The use location 900 may also include a task location 906. The task location may be where tasks are performed using materials to transact or use an asset.

FIG. 9B shows an example of different areas that may be established for geofencing at the use location 900. Area A shown a boundary 910 may include the entirety of a certain use location 906 (e.g., playing field). Area B 912 may be a portion of the use location, such as where asset is stored. Area C 914 may be another location and area D 916 may be the entire use location. Individuals may have access to none of these areas or to a subset of these areas, including all areas.

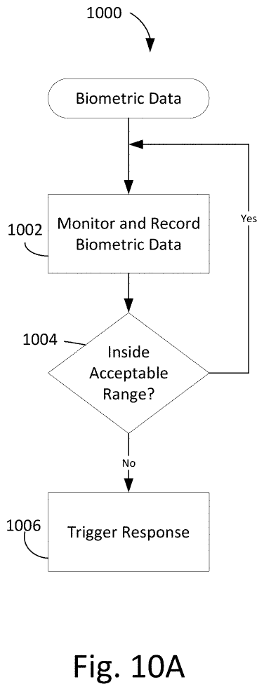

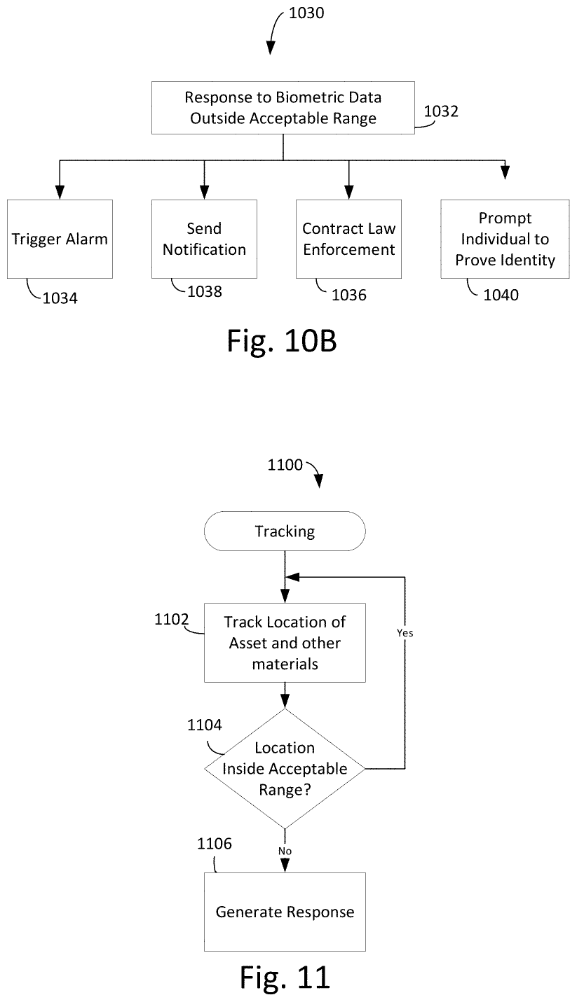

Referring to FIG. 10A, biometric data is capture and recorded as 1002. If the individual associated with the biometric data is not approved to be within an area or to perform a recording or other activity at 1004, a response is triggered at 1006. Referring to FIG. 10B, if the biometric data shows that an individual is outside an acceptable range, an alarm can be triggered at 1032, notification of the alarm can be seat at 1038, law enforcement can be contacted at 1036 and the individual can be promoted to prove his identify at 1040.

Referring to FIG. 11, the system may track the asset at the use location 1102. The system can check whether the location of the asset or other materials is acceptable or not 1104. For example, suppose that a baseball has been delivered to a trade show, The location of the trade show indicates that the baseball is removed from the trade show. This would be problematic and would warrant a response if such removal was unauthorized. If the location of the asset is not acceptable as checked hi 1704, a response is generated in 1106.

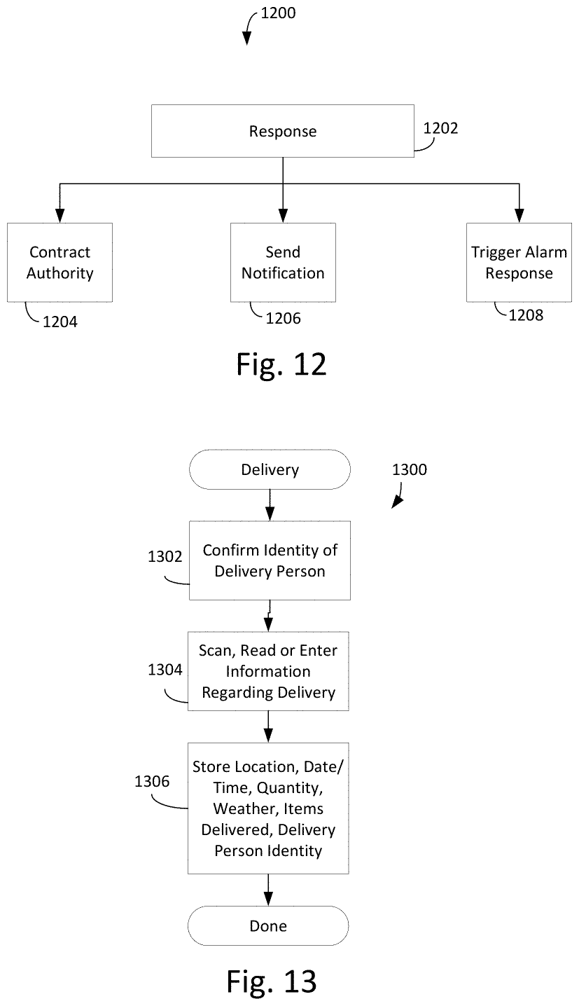

FIG. 12 shows a diagram 1200 illustrating different types of responses 1202 that may be generated in response to the asset in an unacceptable location or an unauthorized access to the asset location. One type of response is to contact law enforcement or security 1204. In many cases the asset may indicate that a theft is underway. Another type of response is to send a notification to an individual or to other appropriate parties at the use location 1206. A final type of response is to trigger an alarm response 1208, such as the sounding of an audio alarm or a video alarm.

The system helps manage deliveries to the site. FIG. 13 depicts a flowchart 1300 showing steps that may be performed regarding deliveries. Initially, the identity of the delivery person is confirmed to indicate that the delivery person is the appropriate party and is permitted access to the use location 1302. For example, a serial number or other identification indicator may be scanned or read from the delivered items. In addition, information may be entered by the delivery person using the housing, such as by entering information via screen 106A (FIG. 1A) 1304. The location of delivery, the date of delivery, the time of the delivery, the quantity of the delivery, the identity of the delivery person and the weather may be recorded as part of the information that is kept regarding the delivery. This information can be used to track and confirm deliveries as well as to understand the conditions when the delivery was made.

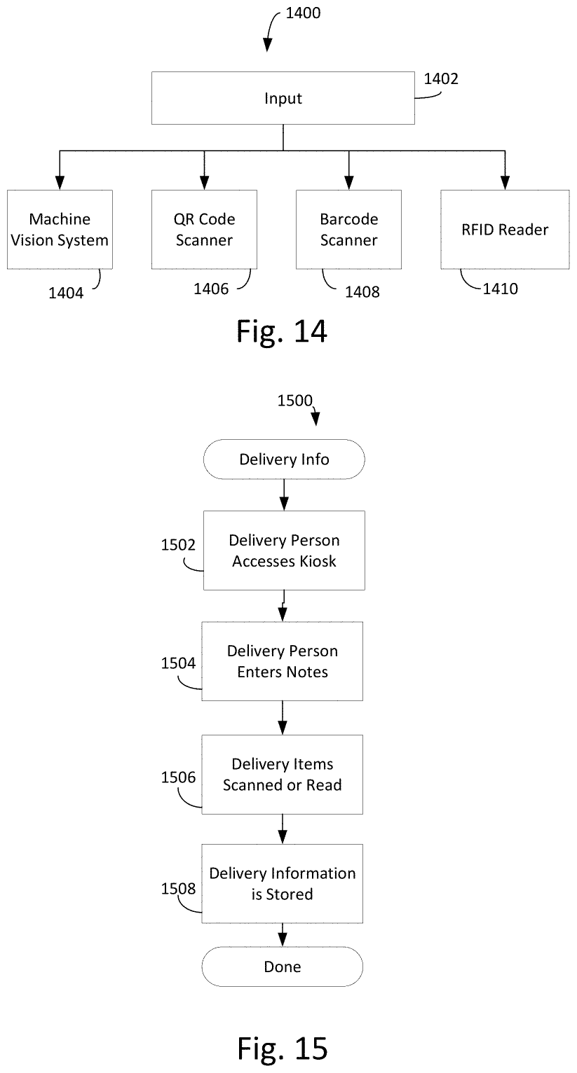

The deliveries may utilize various scanning and reader technology. In FIG. 1A, a scanner 110A may be provided. Diagram 1400 in FIG. 14 illustrates different types of inputs 1402 that may be used for assisting gathering information regarding deliveries, A machine vision system 1404 may be provided. The machine vision system 1404 may capture an image of the delivered items and process the image to determine the nature of the items that were delivered as well as the quantity of items. Moreover, the machine vision system may capture an archival image that may be indicative of the state of the items when they were delivered. A QR code scanner 1406 may be used where QR codes are on a delivered items or documentation. Similarly, a bar code scanner 1408 may be used where bar codes are on the items or on documentation delivered with the items. Still further, an RFID reader 1410 may be provided to gather information regarding the delivered items.

The delivery person may interface with housing via display 106A and 1300 to provide delivery information. Flowchart 1500 of FIG. 15 illustrates some of the steps that may be performed in such an instance. Initially, the delivery person may access the housing 1502, The delivery person may enter a note(s) regarding the delivery, such as what was delivered and the state of the items that were delivered 1504. This information may be entered, such as through the display 106A (FIG. 1A) which can be a touchscreen. The delivered items are imaged, scanned or read 1506. As was mentioned above, several different types of input technology may be used on the delivered items. Therefore, delivery information is then stored in records that may be accessed subsequently 1508.

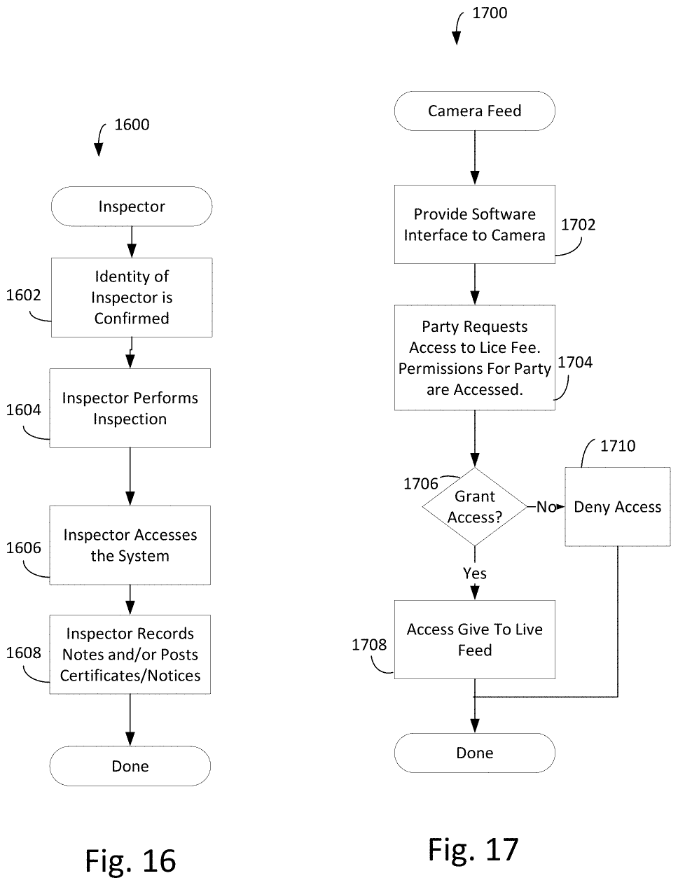

When a transaction, other an original entry of an asset of a subsequent transaction, an individual (e.g., custodian, certifier, inspector, and the like) may interface with the system. FIG. 16 includes a flowchart 1600 illustrating steps that may be performed in such an interaction. Initially, the identity of the inspector may be confirmed using the biometric data 1602 or manually using the touchscreen on the system. The inspector then performs the inspection of the asset at the use location 1604. The inspector then accesses the system at 1606 and provide information about the asset we well as the system reading information about the asset. The individual then may record notes and/or post certificates, notices, or other information at the system 1608. Additionally, the inspector may use technology available via the system such as OCR scanner, camera, or the like to capture appropriate information the individual may include during the recording of the asset or transaction. If the system is at a trade show, for example, the metadata about the transaction can be recorded including the seller, buyer, date, time, location, certification, and the like.

The system may include a still camera(s) or a video camera(s) that can be included in the system. FIG. 17 provides a flowchart 1700 relating to such access. A software interface to the camera may be provided to enable authorized external parties to gain access to the camera 1702. A party requests access to the camera via the interface over the network 1704. For example, a bank official may wish to view the use location before authorizing release of funds or before granting a loan. A determination is made whether the party is permitted access by accessing permissions 1706. The system gathers a great deal of information over the course of time. At least a portion of this information is persistently stored to compile a record of activities at the use location. This record can be useful to prove activities after the fact. The activities that are recorded may drive workflow and scheduling at the use location to improve efficiency. If the party is permitted access, access is given to the party so that they may receive a captured image or video data 1708. Otherwise, access to the camera by the party is denied 1710.

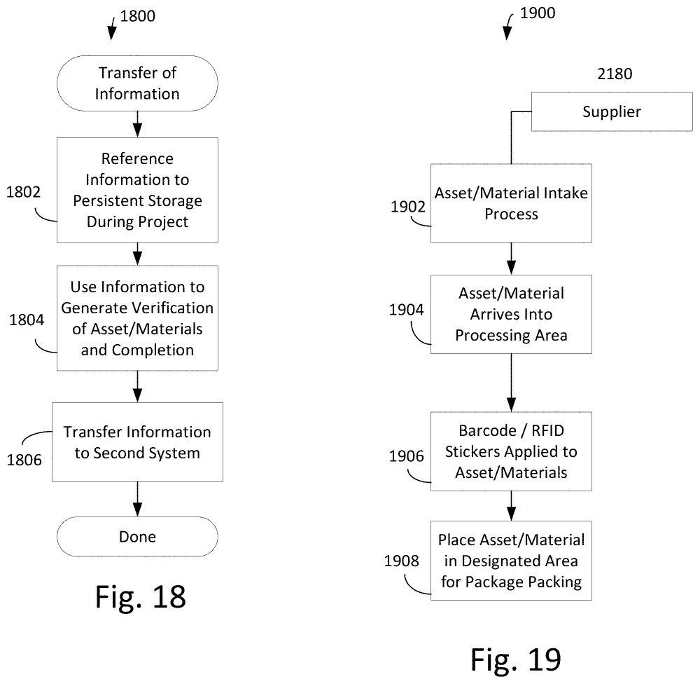

As has been mentioned above, a great deal of information may be collected and stored during the project, process of task for reference during authentication of transactions of an asset. FIG. 18 shows a flowchart of steps 1800 that may be performed in exemplary embodiments in relation to the information. The information obtained about the asset can be derived from many different sources may be stored on or referenced from persistent storage 1802. This information may help resolve disputes between parties concerning authentication. Since there is a complete record on the persistent storage of all transaction, individuals, activities, tasks, locations, and the like associated with the asset these records may be accessed to resolve the dispute. Insurance providers may access these records referenced on the persistent storage to provide insurance or confirm claims. Inspection records may be accessed to confirm that proper inspections were carried out and passed.

A certification can be made a stored at 1804. The certificate of authenticity can be based upon the asset and its transactions and stored on the persistent storage.

The information referenced in the persistent storage may also be accessed from a computing device of an owner, seller, buyer, inspector, proposed buyer, insurance entity, creditor, customer, and the like at 1806. In exemplary embodiments, information may be gathered from and sent to multiple parties including a managing company responsible for the management and oversight of an asset.

The manufacturing company 1910 is responsible for the it take of materials specified in the material requirement record that are needed for the project or process. FIG. 19 shows a diagram 1900 of steps taken in the material intake process 1902. Materials arrive 2914 at a processing area of the supply company 1910 from the manufacturers and/or distributors. Items such as barcode stickers, QR code stickers, Bluetooth beacons, UHF stickers and/or RFID stickers are applied to the materials 1906 so that the materials may be identified and tracked. The materials with the stickers applied are placed in a designated area for packing 1908. The materials may then be packaged for shipment to the use location.

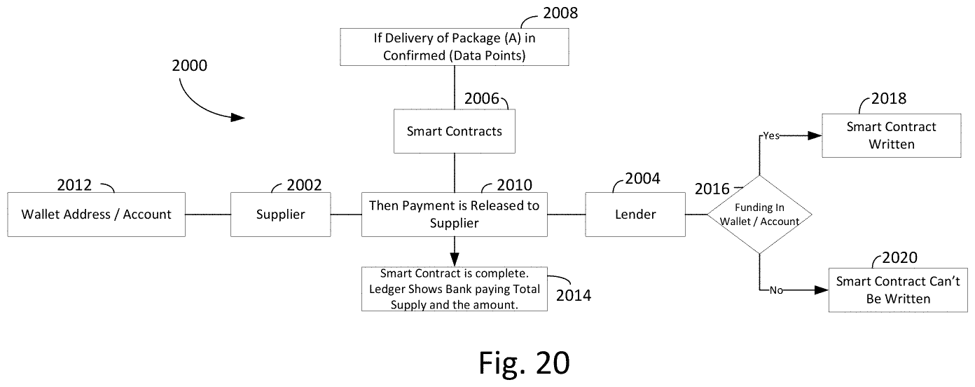

FIG. 20 shows a diagram 2000 of a first example of interactions relating to a smart contract for the project or process. Suppose that the supply company 2002 makes a delivery to the use location. Further suppose that the delivery is confirmed 2008 by information such as that gathered by the system as discussed above. The payor 2004 then releases payment 2010 to the supply company 2002. Payments can be made through third party funding, factoring, credit lines, loans, or other financial option to assist with financing and cash flow management.

The payment may be made electronically, such as through crypto currencies, like Bitcoin or Ethereum, or via a stable coin whose value is pinned to an item like a paper currency or the like. A cryptocurrency is a digital currency built with cryptographic protocols that make transactions secure and difficult to forge. Other Suitable forms of electronic payment includes Automated Clearing House (ACH) payment, Electronic Funds Transfer (EFT), card payments, other types of bank transfers or other types of electronic wallet transfer. In the case where crypto-currency is used, the crypto-currency may be delivered to the digital wallet of the supply company at a specified wallet address or account 2012. The ledger may be updated to show that the contract is complete 2014. Payment requires that the lender has sufficient funding in their digital wallet 2016. If not, the smart contract will not be written on the persistent storage 2018. If there is sufficient funding, payment is made, and the contract is written onto the persistence storage as complete at 2020.

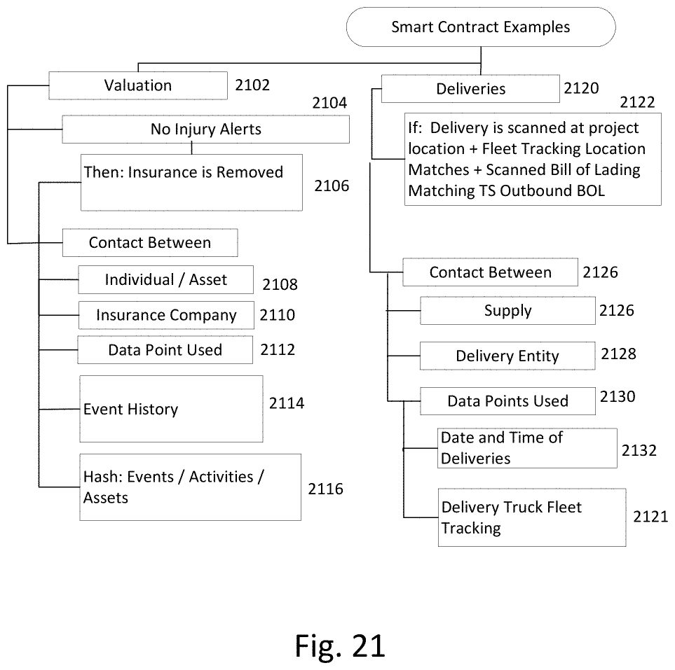

FIG. 21 depicts a diagram 2100 for multiple illustrative smart contracts. In a first illustrative smart contract, the smart contract concerns individual or asset insurance 2102. The contract removes the insurance for an individual or asset 2106 if there are no injury alerts for a given individual or asset 2104. The smart contract can be between entities such as originator, seller, etc. 2108 and an insurance company 2110. The contract looks at the data points 2112 of event history 2114 gathered by a wearable for the individual and any fall reports 2116 from a wearable for the individual.

A second illustrative smart contract shown in FIG. 21 relates to payment for a delivery 2120. If a scan is made at the delivery site, if the fleet location tracking information matches the desired delivery site location and if the scanned material list at the delivery site matches the outbound material list from the supply company 2122, then payment from the supply company 2126 to the delivery individual 2128 is made. Data 2130 used by this illustrative smart contract 2130 includes date and time of deliveries 2132 and delivery truck fleet tracking information 2121.

A third illustrative smart contract shown in FIG. 21 relates to valuation at 2102. If the valuation by an individual results in no injury or other damage and authentication to the asset, insurance for such activity as storage or shipping can be removed at 2106. The asset, once authenticated, can by insured at 2108 by company 2010 with data from the persistent storage 2112. The events can be stored at 2114 and archived at 2116. If the asset if to be delivered, the delivery process can begin at 2120. The asset can be delivered according to a smart contract at 2121 with a supplier or other origination source 2126. The delivery can be through delivery entity 2128 and with data used to verify the delivery at 2130 and 2132 including truck tracking 2134. An electronic contract can be automatically executed once verification of the asset, delivery, receipt and other items occurs.

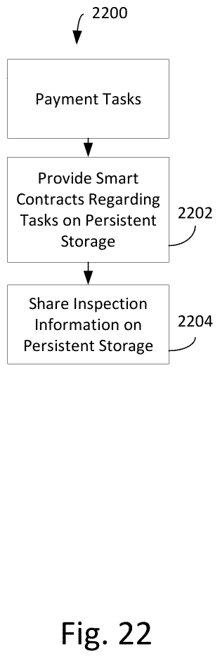

FIG. 22 shows a flowchart 2200 depicting steps performed during the verification project or process and for implementing a smart contract. Initially a smart contract may be initiated that uses the blockchain-based distributed ledger, where the smart contract is for at least a portion of a transaction associated with the project or process 2202. An inspection of the object, event or transaction under a contract can take place and information regarding the event can be passed through a hash function resulting hi a hash value. The hash value may be referenced on the blockchain-based persistent storage 2204.

To pair a material with its virtual representation the system captures events at various points of transition of the material. Pairing the physical material with the virtual representation can include several elements or components. Included in the pairing process can be the physical observation of the physical material and then associate the physical material with a virtual representation so that the physical material is properly associated with the virtual representation. This verification provides truth that the virtual representation is accurately associated with the physical material as a factor rather than simply trusting that the virtual representation is accurate. This system can use manual or automated processes to physically observe the material and associate the material with the virtual representation during various events from raw material to final deliverables. Verification can also use the metadata that is associated with the interaction of physical items by individuals and electronics when the item is created, transported, installed, activated, and destroyed. The metadata that can be captured and placed into immutable storage can provide stakeholders an audit trail of history for their physical asset using a verified paired virtual representation. A similar process as described herein can be used for pairing a biometric identifier with an individual.

By verifiably pairing the physical asset with a virtual presentation, the risk of unintentional or impermissible rehypothecation can be reduced or eliminated. The paired asset can be verified by multiparty chronological metadata streams that can be associated with a physical location. Because verifications using these streams are chronological, altering the information could require alteration of the metadata prior to and after the altered record. Therefore, the altered record would be inconsistent with the associated records potentially both temporally and geographically and an attempt to alter the record would be discovered. The use of a persistent storage further reduces the risk of alterations of records as well as increasing the verification of information. Further, pairing assets associated with the event, involving the asset, interactions with the asset and the associated metadata provide for a substantiated digital asset, reduce, or eliminate risk and improve capital efficiency. Further, the pairing of assets facilitates commerce by allowing electronic transactions with assurances that the virtual representation used in the electronic transaction is paired with the physical asset.

Verification, including verification of an event, can include verifying that the physical material and the virtual representation match and can be accomplished in a variation of methods including interaction with identification elements such as a tag, label, and the like, capturing an image of the material, capturing a video of the material, capturing a tag physically affixed or otherwise associated with the material, human visual inspection, and any combination. Identification of an individual performing or otherwise associated with an event can be captured by identification devices (e.g., cards, tags, RF ID) and biometrics including visual capture (e.g., facial recognition), voice recognition, iris scan, fingerprint, palm print and any combination.

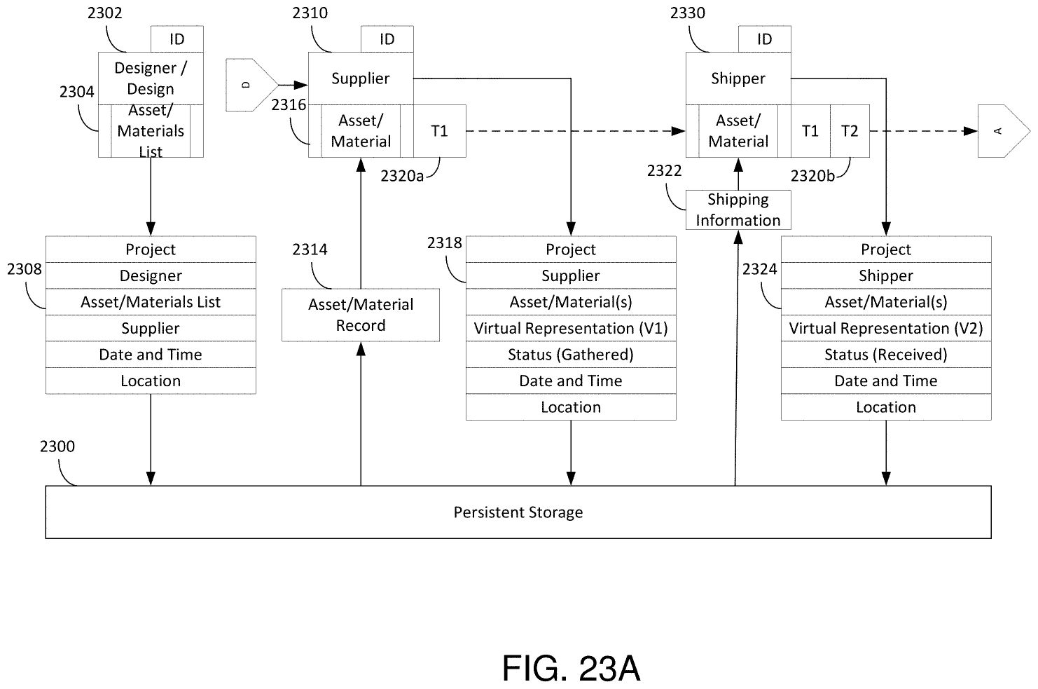

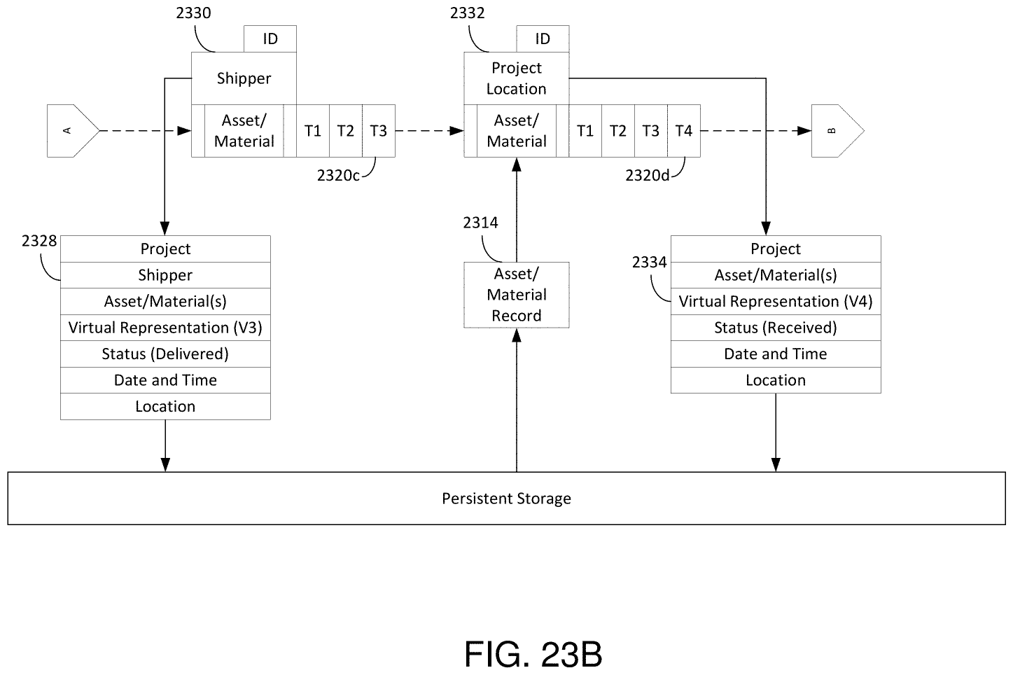

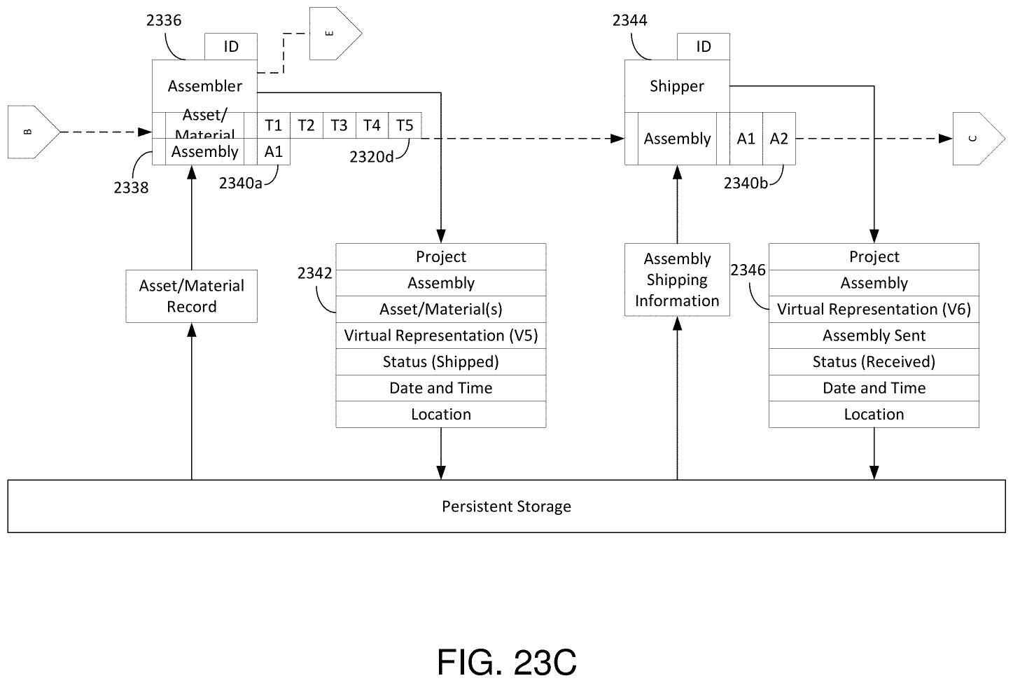

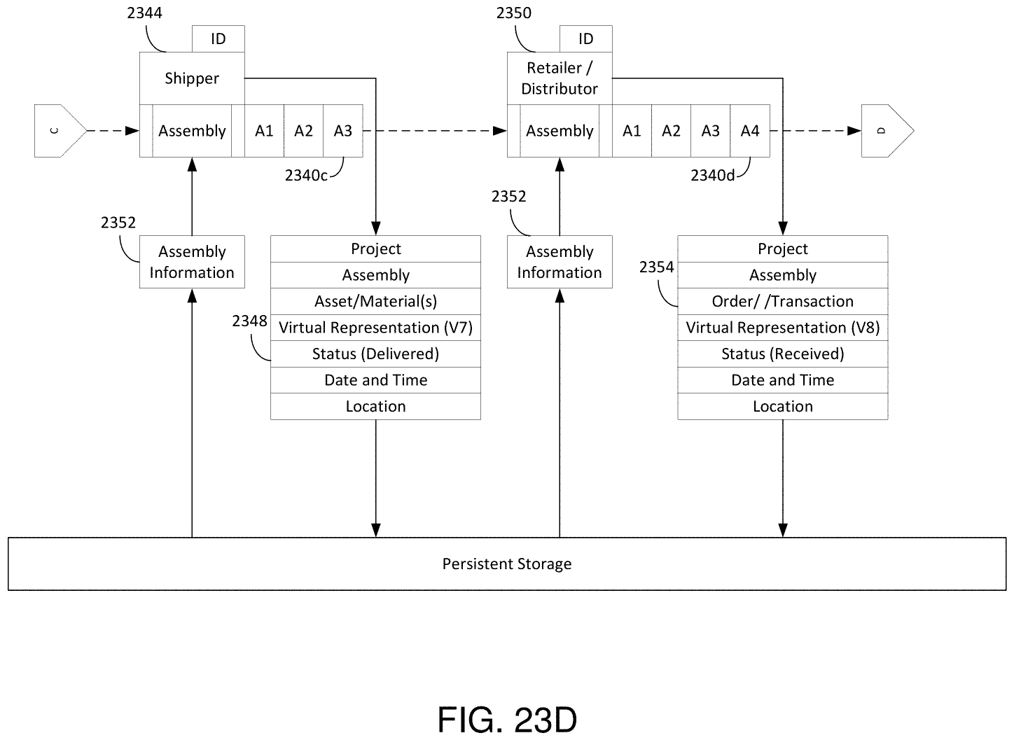

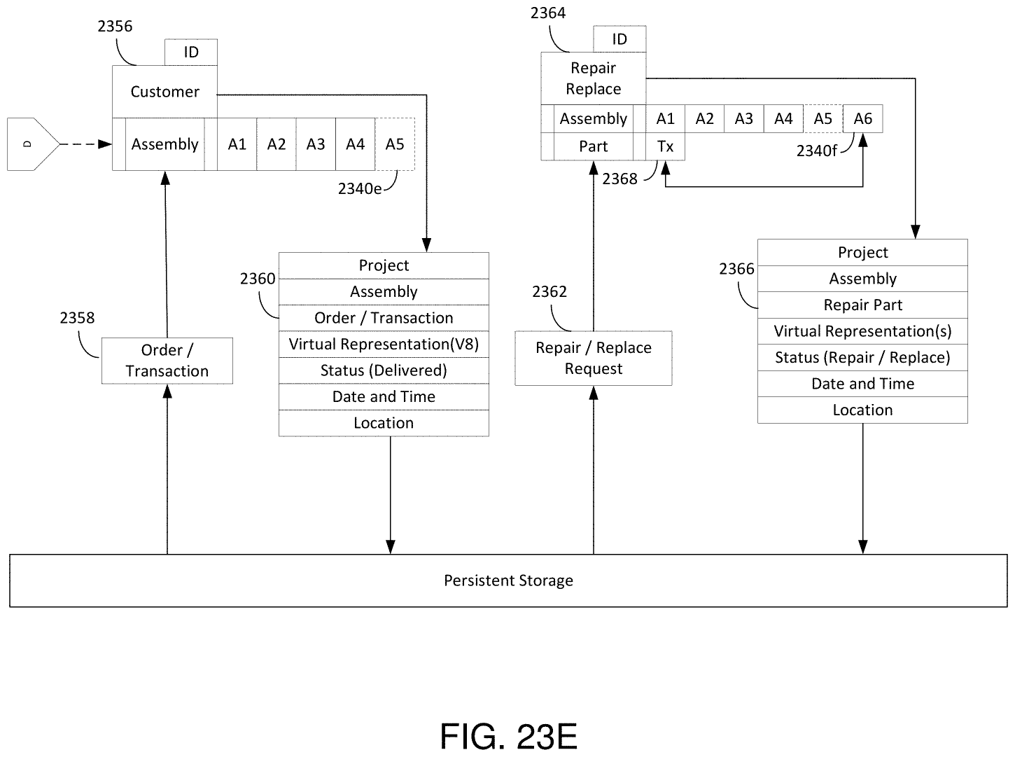

Referring to FIG. 23A, an exemplary embodiment is shown. The persistent storage 2300 is accessible by a designer using a designer computer system 2302. The designer can have a unique ID associated with it. The designer can create an asset design such as materials, shape, part, graphic, project, process, or other item or activity. For example, the asset can be a collectible sports card (e.g., baseball card), sporting equipment, (e.g., baseball)) and can be for general use or specific use (e.g., the World Series). The design can include a material list and other properties for the asset. For example, if the asset is a baseball, regulations and/or request can state that the baseball must have 108 hand-woven stitches to connect two peanut-shaped cowhide leather and measure 9 to 9½ inches in circumference (or 2 55/64 to 2 15/16 inches in diameter. The system can create a designer record 2308 that can include information associated with the asset, its manufacturer, is supplier, use location, material list, supplier for one or more materials, the date and time the design was created or modified and the location where the design was created or modified and other metadata. The design record can be stored on the persistent storage that can be local or remote from the designer.

From the design record, a material record can be created and stored on the persistent storage. The material record can include a single component or multiple components. The requirements for a warranty to remain in place can include requirements such as compliance with installation processes, environmental conditions, use of licensed individuals, use of qualified and experienced individuals and any combination. A warranty can include a traditional warranty associated with the asset or a warranty that the asset record was properly created and performed or that a transaction was properly recorded.

A supplier, using a supplier computer system 2310, can select or otherwise acquire the material 2316 identified on the material list from a materials record 2312 or designer record that can be retrieved or otherwise received by the supplier computer system from the persistent storage. The supplier can verify that the material matches the material requirement record, and the system can capture this event. For example, one method of associating the physical material with a virtual representation is using a tag 2320a (T₁) placed on the material. The tag is then physically verified to be associated with the material from the material list or the material record. Therefore, the physical material and the virtual representation (V₁) are paired by recording this event and associating the physical material, T₁, and V₁. The material can be received by the manufacturer, scanned or otherwise identified with a sensor assembly, inspected by a individual and the manufacturing process recorded. This can include capturing the metadata associated with the material, individual, locations, date, time, and process as stated herein. In one embodiment, the tag can include the following information:

| Description | Digits | Information |
|---|---|---|
| Locations | 19-20 | GPS XX.XXXXXX XXX.XXXXXX |
| User ID | 8 | SSN XXXX + Initials XX + Gender X |
| Date | 10 | XX/XX/XXXX |
| Time | 7 | Zulu XXXX:XX |
| Material | 12 | UPC/Barcode XXXXXXXXXXXX |

A supplier record 2318 can be created and stored on the persistent storage. The capture event can include a unique number and include the supplier ID, date and time, location, material ID, status, and any combination. The material ID can be from an original manufacturer or the supplier, The status can include that the material has been gathered, manufactured, packaged, ordered, is in stock or on back order, shipping information and any combination. The supplier record can include or reference a designer or manufacturing specification record that can include the material and design requirements. The shipping information can include the origin, destination, shipping instructions, shipper, and any combination and can be included in or reference to the supplier record.

Referring to FIG. 23B, a shipper can retrieve shipping information from the persistent storage 2322 identifying the material or asset location, load, destination, pick time, delivery time, and other information concerning the shipping of the material or asset. The shipper can verify that the physical material or asset being retrieved from the supplier match the virtual representation of the supplier record, R the materials are verified, the shipper can physically capture the event, for example, by affixing its tag 2320b (T₂) to the materials representing this verification. A supplier shipping pickup record 2324 can be created and stored on the persistent storage. The supplier shipping pickup record can include project, shipper, material, status, date, time, location, and any combination. The mode of transportation of the material can also be tracked and stored on the persistent storage. For example, if the shipper uses a vehicle, the date, time, location, and other metadata associated with the vehicle can be gathered along the route and stored on the persistent storage. Verification can be provided using the metadata of the various events associated with the material or asset. For example, if the date, time, and location of the supplier record is within a certain range of values of the date, time and location of the supplier shipping pickup record, there will be verification that the proper materials were physically transmitted from the supplier to the shipper.

Referring to FIG. 23C, the use location can be a location that can distribute the asset, add significance to the asset (e.g., a baseball, bat, glove, jersey, or other articles used for a record such as during a xxth homerun or have it signed), authenticate the asset, or other activity. For example, if a baseball is used for a xxth homerun, an individual with authority at the use location (e.g., stadium) can verify the baseball, add a unique identifier, record a pre-existing identifier, capture an image of the asset, have it signed, and any combination and add the information into the system. The system can verify the information using the sensor assembly including capturing information about the asset, individual, event and the like. The unique identifier can be a number, bar code, alpha numeric characters, QR code, RFID, beacon, lot, size, sticker, tag, hologram, label, wireless transmitter, wireless transceiver, physical feature, and any combination. The physical feature can include a surface structure on the asset, a microstructure or other characteristics or manufacturing characteristics such as tool marks. The unique identifier can include material identification added or associated with the asset record.

The system 2336 can be used to retrieve the asset record from the persistent storage. The asset record can be used to match the asset delivered to the use location to verify that the asset is properly associated with corresponding significance (e.g., the xxth homerun, at the corresponding date, time, event, location, and the like). The use location can add tag 2320d (T₅) to the asset, or use other verification methods described herein, to capture the event and the asset. The system can also capture the asset and corresponding event or significance at 2338 by adding a tag 2340a (A₁) to the asset. An asset record 2342 can be created, modified, stored or any combination on the persistent storage. The record can include the event, location, description, virtual representation, date, time, location, other metadata, and any combination.

Once completed, the asset can be delivered to another location such as through a sale or loan of the asset. The asset record can include shipping information, or an asset shipping record can be created and stored on the persistent record. If the asset needs to be delivered, a second shipper can use a second shipper computer system 2344 to retrieve the shipping record, asset record or other shipping information that is used to identify the origin, locations, asset, pick up time, delivery time and other information associated with the transportation of the asset from one location to another and from one owner to another. The asset can be received by the second shipper and the second shipper can capture the event such as with a tag 2340b (A₂) to the asset record representing that the asset has been verified by the second shipper as properly provided and received by the shipper. A second shipper pick up record 2346 can be created and stored on the persistent storage.

Referring to FIG. 23D, the second shipper can deliver the asset to a retailer, distributor, or customer. The asset can be transferred from an original owner to a subsequent owner. When the second shipper delivers the asset to a retailer or distributor, the second shipper can create a second shipper delivery record 2348 using a second shipper computer system 2344. The second shipper can capture the event such as using a tag 2340c (A₃) representing that the proper asset was delivered to the proper location. The second shipper can use the verifications that are part of the virtual representation to match A₃ with the asset and the information stored on the persistent storage.

The retailer or distributor computer system 2350 can be used to verify that the asset is properly delivered by retrieving the asset record 2352 or second shipper record 2348 from the persistent storage and using the record to match the physical asset delivered. The retailer or distributor can capture the event and can add a tag 2340d (A₄) representing that the proper asset was received at the proper location. A retailer distributor record 2354 can be created and stored on the persistent storage. Therefore, when a subsequent entity wants to verify the asset authenticity, the persistent storage includes the audit trail and chain of custody for the asset. For example, if a baseball originates as a baseball game and has some significance, the baseball may be purchased from the event host, from the participant, league, or even team. Significance of an asset can be any occurrence, event, individual or other circumstances which differentiates the asset from other assets. For example, a baseball that is used during a World Series game has increased significance from one used by a team at a practice. The significance can increase the value of the asset,

A baseball league may originally have ownership of the baseball and therefore the right to transfer the baseball to a second entity. The transaction can be recorded that can include the device ID of the kiosk, tag information of a tag associate with the asset, exchangeable image the data or other data associated with a photo of the asset, biometrics of the certifier, seller, buyer or other individual associated with the asset, location and time certifications of certifier, buyer, and seller, wallet confirmation (in the event that the asset is digital such as with a NFT or physical items), asset number, hash confirmation, audit information, location over time for the asset and other information described herein. The system can also store assets and transactions associated with the buyer and seller and generate transaction history for the buyer and seller, jointly or separately that can include the data described herein.

Referring to FIG. 23E, a buyer can receive the asset as using a computer system 2356 to retrieve or otherwise receive an order record 2358 from the persistent storage or other system requesting that a customer receive the asset. The system can be located at a trade show or other location where a transaction can occur. The buyer or recipient of the asset can receive the asset using the system as described herein with a shipper performing the steps and the system performing the steps associated with the shipper and second shipper above. The buyer can receive the asset physically at a second location such as a trade show. A third shipper can create a third shipper pickup and delivery record that can be stored on the persistent storage verifying that the asset was properly provided from the owner or distributer to the customer or buyer. The customer may capture the event and can add a tag 2340e (A5) to the asset that can be associated with the virtual representation (Vs). A customer record 2360 can be stored on the persistent storage.

Using this system, the buyer or other entity can be assured that the asset was independently verified and authenticated from the original creation of the object, from the manufacturer to delivery at the venue or event location, the anchored location the immutable time verification biometrics of officials and or event participants and pictures or other unique identifiers of the object itself at the event. Original owner or certifying entity, for example a sports league. Therefore, when purchase an asset, such as collectibles or memorabilia, the authenticity can be quickly and easily verified at the location of purchase (e.g., trade show) by accessing the persistent storage without the need for a third party or professional authentication process.

The system described herein can pair the physical material (e.g., asset) with a virtual representation. Failure to pair the asset with the virtual representation can negatively impact areas such as authentication, certification, fraud prevention, and the like. Tracking, management, and verification of materials and assets to ensure authenticity and use and manufacturing is an important aspect to many assets and their valuation. Tracking and record keeping during the life of an asset from its creation to use can be difficult to perform without the ability to pair the asset with ah virtual representation.

Systems at multiple locations may be interconnected using image capture devices, RFID, QR codes, barcodes, biometric scanners, still cameras, video cameras, and the like to identify individuals or machines that are performing verifications during the process. Further, multiple individuals or machines are performing verifications so that there is not a reliance upon any one entity for verifications. The processing of capturing data, including images, from the multiple systems at multiple locations can be used to improve the verification of proper materials and assets as well as to pair the physical items with the virtual representation.

By using the various tags and virtual representations, each entity in the process can verify that the physical materials match any record the precedes that entity.

This process can include internal and external individuals and machines for performing inspections (e.g., verifications). For example, the system can receive a set of internal inspection information entered into the system from an internal inspector representing an internal physical inspection of the project, material or assembly. As the items travel, an internal inspector can provide inspection information representing the stages of the project. The system can also receive a set of external inspection information from an external inspector and an external inspection computer device representing a third-party physical inspection of the project at predetermined stages of the project. Based upon the internal inspection, external inspection or both, an inspection record can be created and stored on the persistent storage.

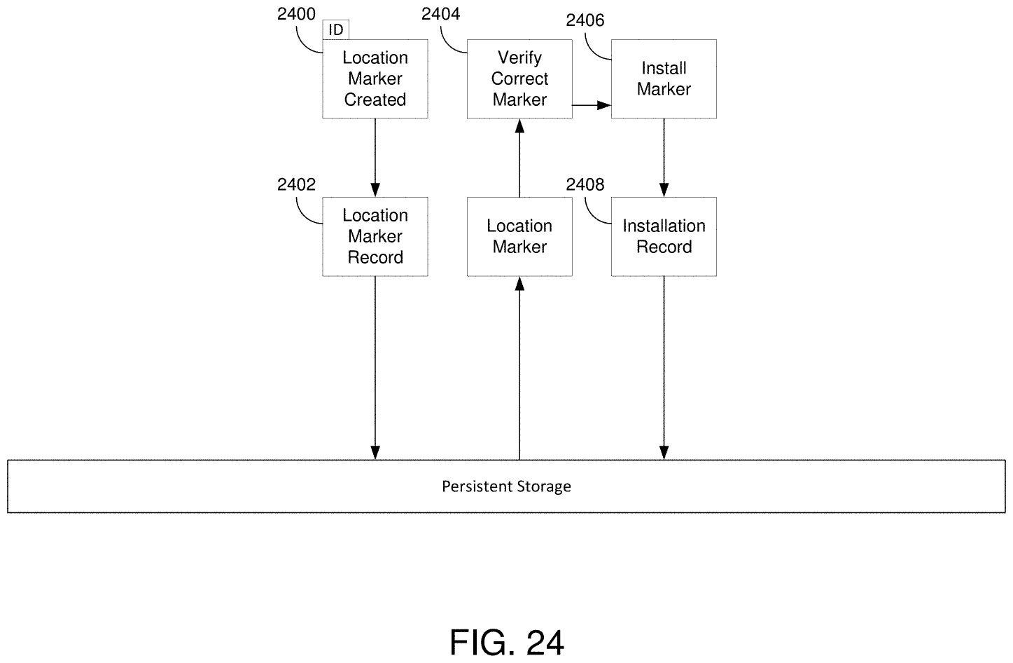

Referring to FIG. 24, a location marker 2400 used to uniquely identify a location such as a use location and can include a stadium, playing field, trade show, retail location, distributor, wholesale location, warehouse, asset location, or other physical location. The location marker can be a barcode, RF ID, placard, sign, plaque, QR code, or other symbolic, alphanumeric, digital, or electronic identifier. When creating the location marker, a location marker record 2402 can be created that includes the location marker identification information, creation date, maker, manufacturing location and other information that can be stored on the persistent storage. The installed information can retrieve the location marker record and match the retrieved information with the physical location marker to verify that the correct location marker is being installed at 2404. The installed can physically install the location marker and using a GPS enabled device, read the location marker, and create a location marker installation record 2408. The installation can be paired with the physical location marker and/or the physical location of the project. The metadata from the GPS enabled device can be included in a location marker installation record that can also include installer information, date, time, location marker information and physical location information and can be stored on the persistent storage. Therefore, the physical location marker is verified to be paired with the use location and a virtual representation of the location market and use location.

The system can be used to confirm a baseball manufactured with specific materials and design specifications from the manufacturer being shipped to a baseball stadium. The shipment may contain unique identification such as lot, date of manufacture, etc. The arrival of the baseball at the stadium can be the confirmation and included in the asset record to verify the location and time of arrival. Within a predetermined period of time of arrival at a use location, the baseball can be used in a game whereby for example the visiting team pitcher would use the baseball and pitches to the home team notable player, the notable player could then hit a homerun into the home team bullpen. The baseball would easily be retrieved by stadium or other personnel associated with the use location, team, league, and the like. The baseball could then be taken to the computing device where the official could place a unique identifying tag on the baseball and registering it at computer device and kiosk. The kiosk can confirm the location, and the time of registration by immutably recording the baseball into a digital asset record. The biometrics of the official would then be recorded into the same record.

The participant or in this case player could then sign the baseball or have the players biometrics registered to the digital asset record. This confirmation of location time as to when the recording event occurred the ball itself as well as the biometrics of the official and player can create the digital pairing of the asset. The baseball can then be placed for sale on an official league, team, or other entity exchange for digital paired assets, sold at a retail location, or placed on an auction or other means to solicit and then transfer ownership. A potential purchaser could identify the asset record by the marking or identifying tag or sticker on the baseball and look up the corresponding immutable data in the asset record to verify the date time, location, biometrics, and other relevant information to the paired asset. The asset would then be sold to the initial owner outside of the originating entity and or parties. The new buyer would have their wallet or other unique identifier, such as their biometrics recorded into the paired digital asset record as the registered owner.

A digital wallet could hold this paired digital asset that would give the owner anonymity but proving their ownership. In the future if this owner wished to sell the paired digital asset a new buyer could evaluate the asset in question for purchase by confirming the relevant to data in relation to the sporting event where the memorabilia or object was used. The genesis of the item becoming memorabilia and not just an object. The seller could then authenticate the asset by providing a token to their digital wallet to confirm that their digital wallet contains the paired digital asset record of that baseball and agreed to price between the parties could be entered into a smart contract tied to shipping information whereby the physical object could be shipped or sent to the new buyer and upon confirm delivery by a third party logistics or supply company the new buyer could register their location through location information and confirm the time of purchase or transfer of the asset through theft personal computing device or by going to a location with a computer device and kiosk.

The funds could be placed in an escrow account whereby upon confirm delivery the funds are transferred to the original owner or initial owner and the paired digital asset is transferred from the original owner's wallet to the new owners wallet making their wallet the new owner of record. As the paired digital asset database is immutable a historical or chronological record of all wallets that the asset had been in would be kept proving additional provenance on the item for future buyers the paired digital asset database could be referenced or endorsed by the major-league baseball league and each time a sale was to occur a fee, commission, could be paid to major-league baseball, the players or other identified relevant parties. The new owner can have the digital asset and physical asset transferred in this matter to provide verifiable provenance of the item in continuum for future value confirmations, sales or other transactions.

For example, should the new owner want to take the baseball to a tradeshow and sell the baseball. A computer device could be present to record location, time, and biometric confirmation from seller to buyer as well as to scan the object itself and confirm that the unique identifier matches the original asset such as by using a tag. At a tradeshow the owner of the object can physically take the baseball to the computer device (e.g., kiosk) authenticated through the scanning of the affixed identifier, confirming the party's identity through biometric scan and confirm the location of the event where transaction occurs including the time of the transaction. The buyer could enter wallet information, confirm theft biometrics, and effectuate the value transfer through smart contract or in person payment. Upon confirmation of payment by the seller the digital paired digital asset would be transferred to their wallet and the kiosk could confirm. Pairing the actual sale transaction in this way would give further assurance that the item is the object paired with the digital asset immutable database.

One of the most forged items is memorabilia or items that have been signed by an athlete, performer, politician, or other. It is often impossible to authenticate signatures as some signatures can be easily copied, In the case of using the system to digitally paired memorabilia an athlete could sign these items at a tradeshow and use the kiosk at the key tradeshow to authenticate or digitally pair the items using their biometrics, the location anchoring, the time and pictures through the kiosk of the item. Each item can be given a unique asset number which future purchasers could confirm the asset number relative to the item being bought, sold, or traded it would be of great advantage for athletes and others to digitally pair all memorabilia and other items that they sign to the system to ensure authenticity. This can increase the market value of items as well as reduce or prevent fraud.

The athlete signing individual can go to a retail location that contained the computer system (e.g., kiosks), sign the asset (e.g., jerseys, balls bats etc.) and then each item can be registered in the paired digital asset database immutably recorded. The athlete could use biometrics to confirm the authenticity of each item being signed. Each item would be entered into the paired asset database the athlete could be assured that the items being sold were paired to them and the buyers of said items could register as the owner of said item. In the future should that item be transferred or sold again the new owner could follow the previously outlined process whereby ownership transfer would occur immutably with confirmations. Each time there was an asset transfer a fee could be paid to the player providing an income stream to the player and league.

What is claimed is:

1. A computerized system for verifiably pairing a physical asset with a digital representation comprising:
a computer system disposed at a use location and in communication with a persistent storage;
a physical asset having a unique identifier;
a set of non-transitory computer readable instructions included in the computer system adapted for:
retrieving, from the persistent storage, an origination record according to a first verification representing verification that the asset is paired with a first virtual representation stored on the persistent storage,
associating significant information with the unique identifier wherein the significance information is associated with the use location and wherein the significant information is taken from the group consisting of date, time, event, team, individual, notation, and any combination,
creating an asset record having the unique identifier and according to the origination record and the significance information, and,
storing the asset record in the persistent storage.

2. The system of claim 1 wherein the origination record includes information of a first individual confirming significant information and associating the significant information with the asset.

3. The system of claim 2 wherein the origination record includes a manufacturing information associated with the asset.

4. The system of claim 2 wherein the use location is taken from the group consisting of sporting stadium, asset manufacturing facility, distribution facility, sales location, gallery, studio, IP address and any combination thereof.

5. The system of claim 1 wherein the asset record includes a shipping information received by the computer system from a shipper computer system and the shipping information includes a second verification representing that the asset received at the use location is the same asset send by an originator and received at the use location.

6. The system of claim 1 wherein the origination record includes a raw material information representing a raw material used to make the asset and a manufacturing verification information representing that a manufacturer physically verified that the material used in the asset is the same material used in a design associated with the asset.

7. The system of claim 1 wherein the asset record includes a material information representing the material used to make the asset.

8. The system of claim 1 wherein the significance information includes biometric information of an individual verifying that the asset is associated with an event associated with the asset.

9. The system of claim 1 wherein the significance information includes biometric information of an individual using the asset during an event.

10. The system of claim 9 wherein the event is taken from the group consisting of a sporting event, political event, entertainment event, transaction event, signature, autograph, nostalgic event and any combination thereof.

11. The system of claim 1 wherein the significance information includes biometric information of an individual during a transaction associated with the asset.

12. The system of claim 1 wherein the significance information includes information associated with a creation of the asset.

13. The system of claim 1 wherein the set of non-transitory computer readable instruction are adapted to retrieve the asset record, receive a buyer information, receive a seller information, associate the virtual representation with a transaction according to the buyer information and the seller information, create a transaction record according to the transaction, asset record and a transaction verification information.

14. The system of claim 13 wherein the transaction verification information is taken from the group consisting of a biometric information of the buyer, biometric information of the seller, buyer identification, verification of the seller, verification of the asset and any combination.

15. The system of claim 13 wherein verification of the asset includes capturing an image taken of the asset at a transaction location, transaction date, transaction time, transaction event, buyer, seller of any combination thereof.

16. The system of claim 15 wherein the transaction location includes a location marker associated with the location; and,
the computer system is uniquely paired with the transaction location using the location marker.

17. The computerized system of claim 1 wherein the origination record is created according to a physical verification of a first tag affixed to the asset.

18. The computerized system of claim 1 wherein the origination record is created according to a physical verification of the location of the asset using a global positioning system.

19. The computerized system of claim 1 wherein the set of computer readable instructions can be adapted to creating a buyer record representing the buyer of the asset and storing the buyer record on the persistence storage.

20. A computerized system for pairing a physical asset with a digital representation comprising:
a computer system disposed at a use location and in communications with a persistent storage;
a sensor in communications with the computer system;
a set of non-transitory computer readable instructions included in the computer system adapted for:
creating an asset record using the sensor representing a physical asset associated with a virtual representation wherein the virtual representation is included in the asset record and includes asset information taken from the group consisting of date, time, event, team, individual, notation, and any combination,
creating a significance record using the sensor having significance information taken from the group consisting of date, time, event, team, individual, notation, and any combination,
associating the significant record with the asset record, and
storing the asset record and the associated significance record on the persistence storage.

21. The system of claim 20 wherein the asset record and the associated significance record are configured to be retrieved from the persistence storage from a third-party computer system and adapted to verify that the physical asset is authentic according to the asset record and the associated significance record.

22. The computerized system of claim 20 wherein the computer system is contained in a device taken from the group consisting of a kiosk, tables, laptop, portable device, smart phone and any combination.

23. A computerized system for verifiably pairing a physical asset with a digital representation comprising:
a computer system disposed at a use location and in communication with a persistent storage;
a sensor assembly in communications with the computer system;
a physical asset having a unique identifier;
a set of non-transitory computer readable instructions included in the computer system adapted for:
creating an asset record using the sensor assembly representing a physical asset that is paired with a virtual representation,
creating a significance record using the sensor having significance information,
associating the significant record with the virtual representation
storing the asset record and the associated significance record on the persistence storage,
creating a transaction record representing a transfer of the asset from a first entity to a second entity wherein the transaction record includes a transaction verification,
transmitting a payment request according to the transaction verification to a second entity account representing payment for the asset from the second entity to the first entity, and,
storing the asset record and the associated significance record on the persistence storage.

24. The system of claim 23 wherein the significance record includes information taken from the group consisting of date, time, event, team, individual, notation, and any combination.

25. The system of claim 23 wherein the unique identifier is taken from the group consisting of a serial number, bar code, QR code, RFID, beacons, lot, tag, image, material information and any combination thereof.

26. The system of claim 23 wherein the first entity is an originating entity, and the second entity is a buyer.
